(19) United States
(12) Patent Application Publication
(10) Pub. No.: US 2024/0406672 A1
(43) Pub. Date: Dec. 5, 2024

(54) USER INTERFACES FOR FINDING REMOTE INPUT DEVICES

(71) Applicant: Apple Inc., Cupertino, CA (US)

(72) Inventor: Dila SART, San Jose, CA (US)

(21) Appl. No.: 18/679,342

(22) Filed: May 30, 2024

Related U.S. Application Data
(60) Provisional application No. 63/506,090, filed on Jun. 4, 2023.

(51) Int. Cl. H04W 4/02; G06F 3/04842; H04W 4/029

(52) U.S. Cl. CPC H04W 4/023; H04W 4/029; G06F 3/04842

(57) ABSTRACT

Some embodiments described in this disclosure are directed to one or more electronic devices that provide for locating a findable item that is associated with a respective electronic device, different from the one or more electronic devices. In some embodiments, the one or more electronic devices display user interfaces that present information for facilitating finding of a remote input device on an electronic device.

### CROSS-REFERENCE TO RELATED APPLICATIONS

This application claims the benefit of U.S. Provisional Application No. 63/506,090, filed Jun. 4, 2023, the content of which is herein incorporated by reference in its entirety for all purposes.

### FIELD OF THE DISCLOSURE

This relates generally to user interfaces that present information and one or more user interfaces for facilitating finding of a remote input device on an electronic device.

### BACKGROUND

User interaction with electronic devices has increased significantly in recent years. These devices can be devices such as computers, tablet computers, televisions, multimedia devices, mobile devices, and the like.

In some circumstances, users may wish to user such devices to locate and/or navigate to locations of remote input devices. Enhancing these interactions improves the user's experience with the device and decreases user interaction time, which is particularly important where input devices are battery-operated.

### SUMMARY

Some embodiments described in this disclosure are directed to one or more electronic devices that provide for locating a findable item that is associated with a respective electronic device, different from the one or more electronic devices. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4 illustrates an exemplary user interface for a multifunction device with a touch-sensitive surface that is separate from the display in accordance with some embodiments.

FIGS. 5A-5C illustrate block diagrams of exemplary architectures for devices according to some embodiments of the disclosure.

FIGS. 6A-6O illustrate exemplary ways in which a first electronic device facilitates finding of a remote input device that is associated with a second electronic device using a remote-control user interface in accordance with some embodiments of the disclosure.

FIG. 7 is a flow diagram illustrating a method of facilitates finding of a remote input device that is associated with a second electronic device using a remote-control user interface in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods for facilitating finding of remote input devices. In some embodiments, a first electronic device displays a remote-control user interface that is configurable to control a second electronic device, different from the first electronic device. In some embodiments, the remote-control user interface includes a representation of the second electronic device and, in accordance with a determination that one or more criteria are satisfied, a first option that is associated with a remote input device associated with the second electronic device. In some embodiments, while displaying the first option in the remote-control user interface, the first electronic device detects an input corresponding to selection of the first option. In some embodiments, in response to detecting the selection of the first option, in accordance with a determination that the remote input device is within a threshold distance of the first electronic device, the first electronic device initiates a process to find the remote input device. Such techniques can reduce the cognitive burden on a user who uses such devices. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

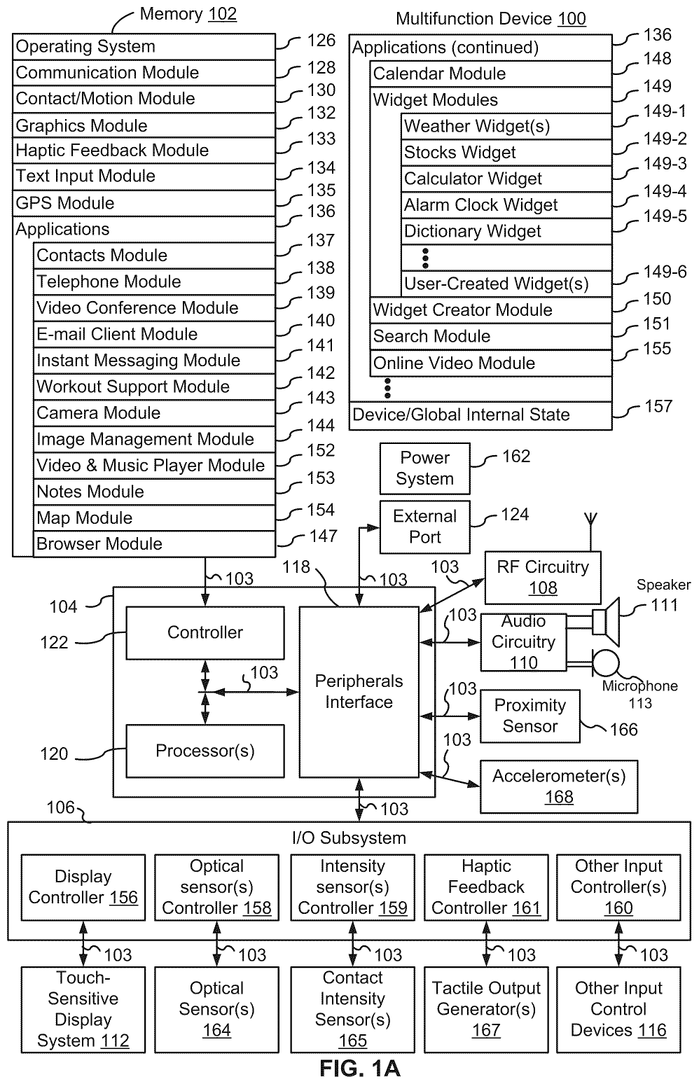

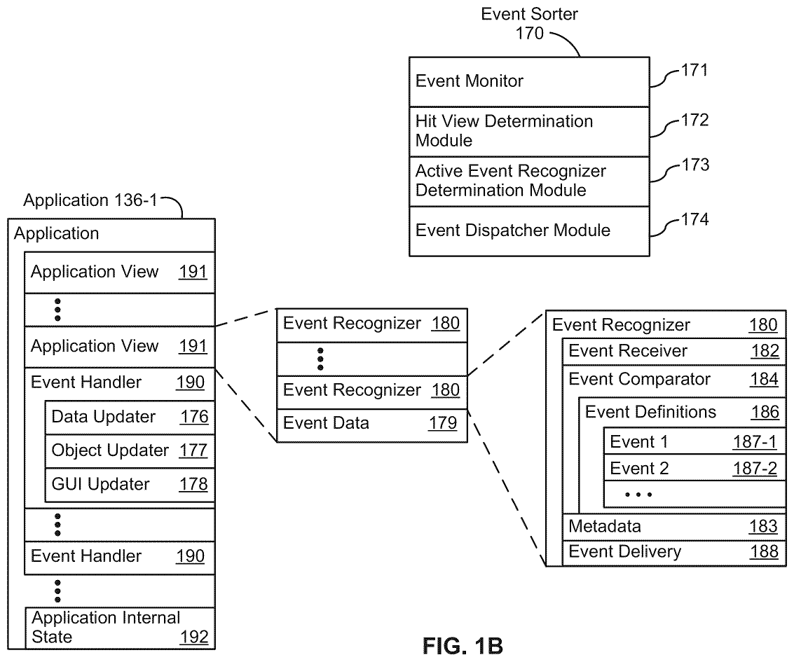

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

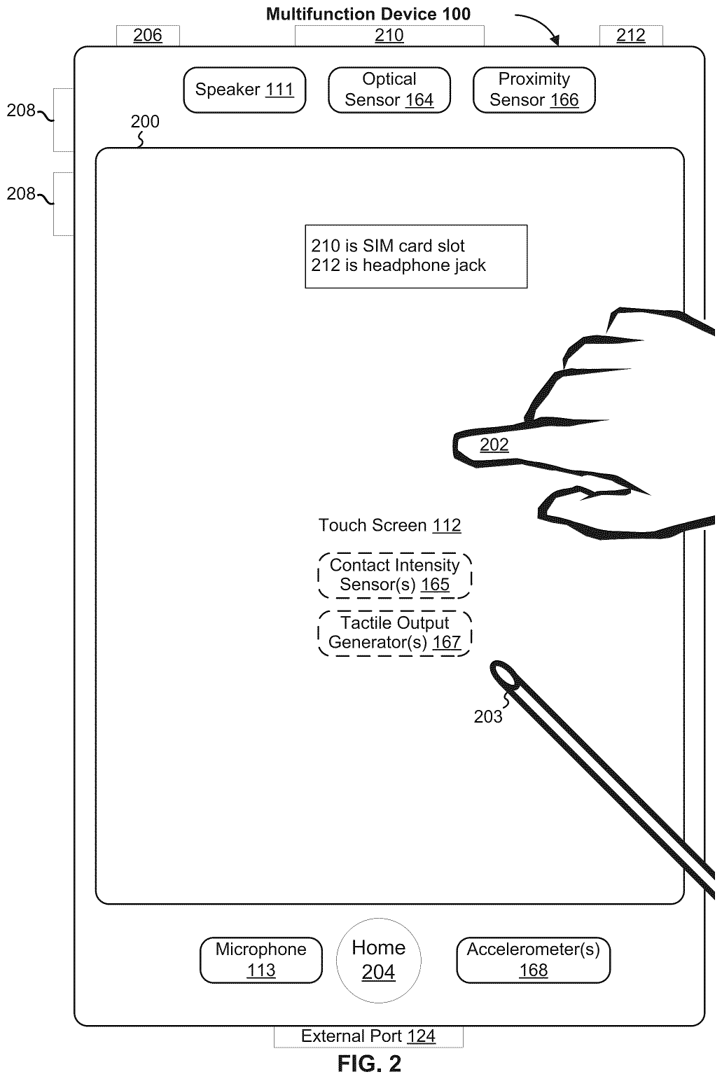

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, device 100 is a portable computing system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system (e.g., an integrated display, touch screen 112, etc.). In some embodiments, the display generation component is separate from the computer system (e.g., an external monitor, a projection system, etc.). As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

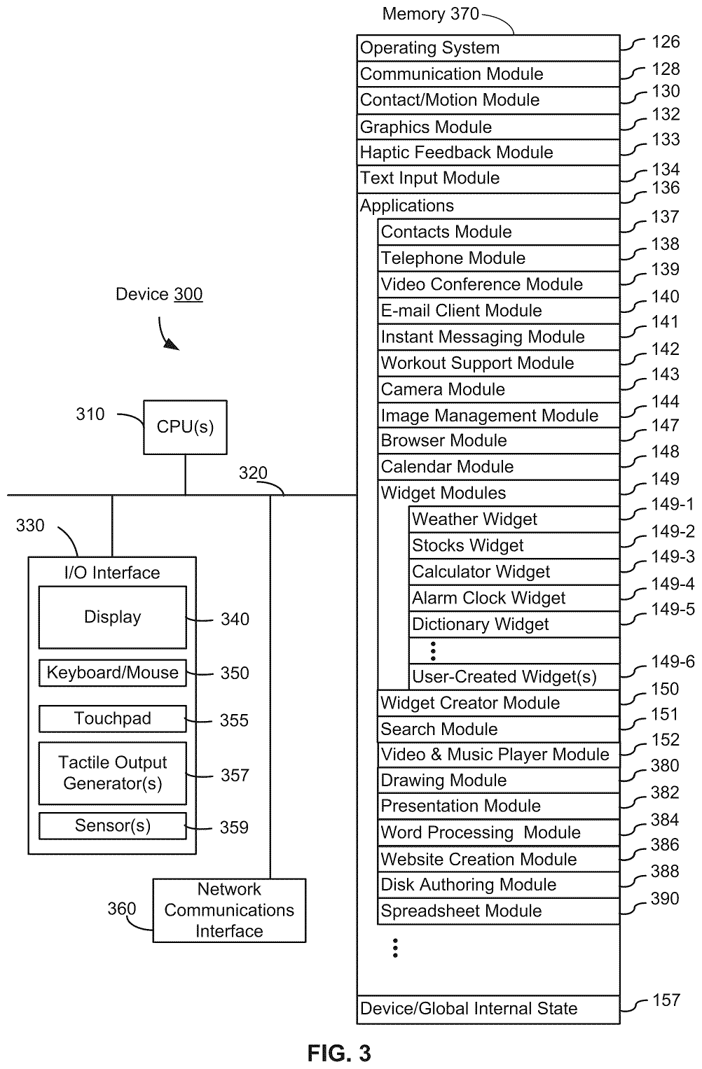

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (arc) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

In some embodiments, stylus 203 is an active device and includes one or more electronic circuitry. For example, stylus 203 includes one or more sensors, and one or more communication circuitry (such as communication module 128 and/or RF circuitry 108). In some embodiments, stylus 203 includes one or more processors and power systems (e.g., similar to power system 162). In some embodiments, stylus 203 includes an accelerometer (such as accelerometer 168), magnetometer, and/or gyroscope that is able to determine the position, angle, location, and/or other physical characteristics of stylus 203 (e.g., such as whether the stylus is placed down, angled toward or away from a device, and/or near or far from a device). In some embodiments, stylus 203 is in communication with an electronic device (e.g., via communication circuitry, over a wireless communication protocol such as Bluetooth) and transmits sensor data to the electronic device. In some embodiments, stylus 203 is able to determine (e.g., via the accelerometer or other sensors) whether the user is holding the device. In some embodiments, stylus 203 can accept tap inputs (e.g., single tap or double tap) on stylus 203 (e.g., received by the accelerometer or other sensors) from the user and interpret the input as a command or request to perform a function or change to a different input mode.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

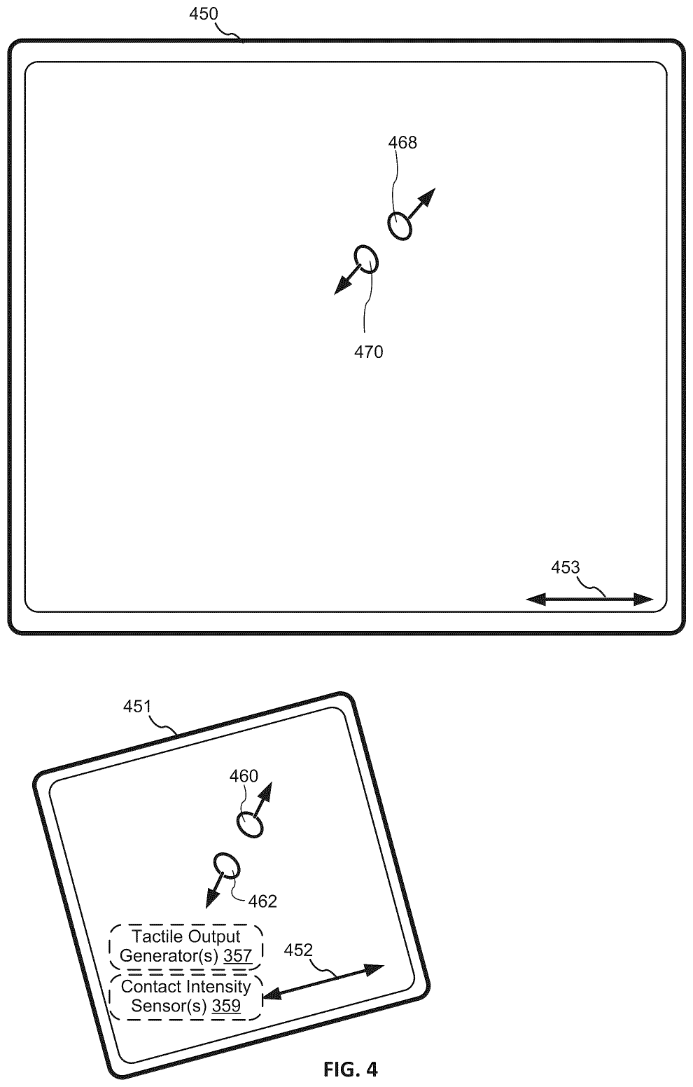

FIG. 4 illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4. In some embodiments, the touch-sensitive surface (e.g., 451 in FIG. 4) has a primary axis (e.g., 452 in FIG. 4) that corresponds to a primary axis (e.g., 453 in FIG. 4) on the display (e.g., 450). In accordance with these embodiments, the device detects contacts (e.g., 460 and 462 in FIG. 4) with the touch-sensitive surface 451 at locations that correspond to respective locations on the display (e.g., in FIG. 4, 460 corresponds to 468 and 462 corresponds to 470). In this way, user inputs (e.g., contacts 460 and 462, and movements thereof) detected by the device on the touch-sensitive surface (e.g., 451 in FIG. 4) are used by the device to manipulate the user interface on the display (e.g., 450 in FIG. 4) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

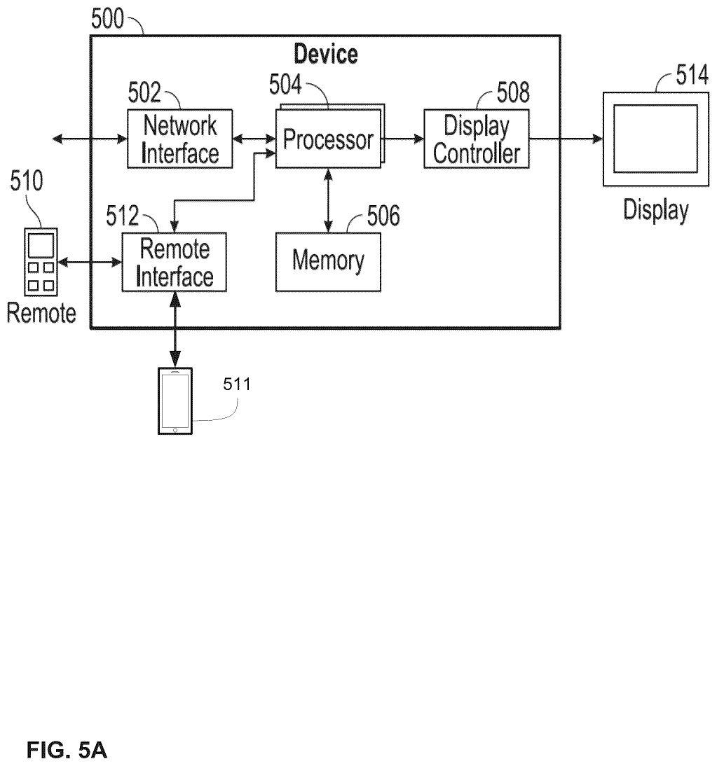

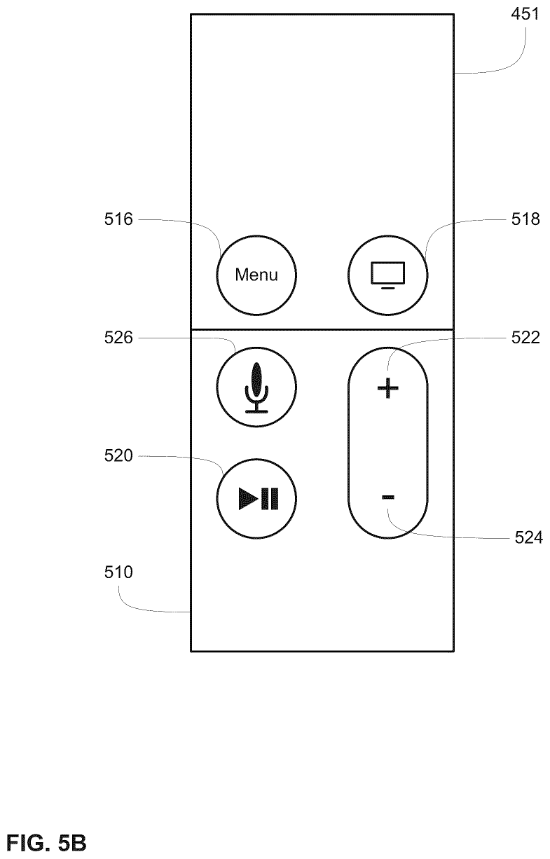

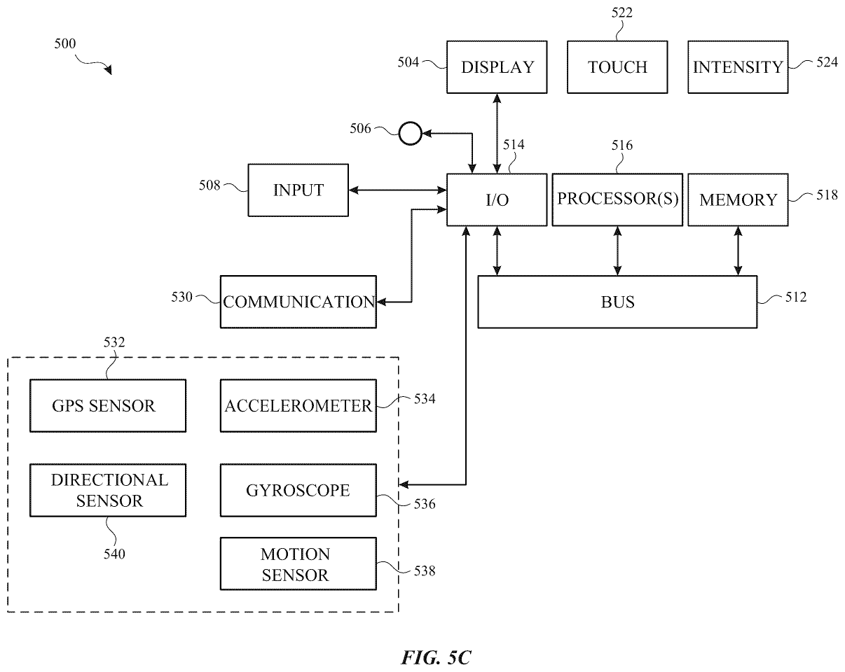

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., method 700).

In some embodiments, display controller 508 causes the various user interfaces of the disclosure to be displayed on display 514. Further, input to device 500 is optionally provided by remote 510 via remote interface 512, which is optionally a wireless or a wired connection. In some embodiments, input to device 500 is provided by a multifunction device 511 (e.g., a smartphone) on which a remote control application is running that configures the multifunction device to simulate remote control functionality, as will be described in more detail below. In some embodiments, multifunction device 511 corresponds to one or more of device 100 in FIGS. 1A and 2, and device 300 in FIG. 3. It is understood that the embodiment of FIG. 5A is not meant to limit the features of the device of the disclosure, and that other components to facilitate other features described in the disclosure are optionally included in the architecture of FIG. 5A as well. In some embodiments, device 500 optionally corresponds to one or more of multifunction device 100 in FIGS. 1A and 2 and device 300 in FIG. 3; network interface 502 optionally corresponds to one or more of RF circuitry 108, external port 124, and peripherals interface 118 in FIGS. 1A and 2, and network communications interface 360 in FIG. 3; processor 504 optionally corresponds to one or more of processor(s) 120 in FIG. 1A and CPU(s) 310 in FIG. 3; display controller 508 optionally corresponds to one or more of display controller 156 in FIG. 1A and I/O interface 330 in FIG. 3; memory 506 optionally corresponds to one or more of memory 102 in FIG. 1A and memory 370 in FIG. 3; remote interface 512 optionally corresponds to one or more of peripherals interface 118, and I/O subsystem 106 (and/or its components) in FIG. 1A, and I/O interface 330 in FIG. 3; remote 512 optionally corresponds to and or includes one or more of speaker 111, touch-sensitive display system 112, microphone 113, optical sensor(s) 164, contact intensity sensor(s) 165, tactile output generator(s) 167, other input control devices 116, accelerometer(s) 168, proximity sensor 166, and I/O subsystem 106 in FIG. 1A, and keyboard/mouse 350, touchpad 355, tactile output generator(s) 357, and contact intensity sensor(s) 359 in FIG. 3, and touch-sensitive surface 451 in FIG. 4; and, display 514 optionally corresponds to one or more of touch-sensitive display system 112 in FIGS. 1A and 2, and display 340 in FIG. 3.

FIG. 5B illustrates an exemplary structure for remote 510 according to some embodiments of the disclosure. In some embodiments, remote 510 optionally corresponds to one or more of multifunction device 100 in FIGS. 1A and 2 and device 300 in FIG. 3. Remote 510 optionally includes touch-sensitive surface 451. In some embodiments, touch-sensitive surface 451 is edge-to-edge (e.g., it extends to the edges of remote 510, such that little or no surface of remote 510 exists between the touch-sensitive surface 451 and one or more edges of remote 510, as illustrated in FIG. 5B). Touch-sensitive surface 451 is optionally able to sense contacts as well as contact intensities (e.g., clicks of touch-sensitive surface 451), as previously described in this disclosure. Further, touch-sensitive surface 451 optionally includes a mechanical actuator for providing physical button click functionality (e.g., touch-sensitive surface 451 is “clickable” to provide corresponding input to device 500). Remote 510 also optionally includes buttons 516, 518, 520, 522, 524 and 526. Buttons 516, 518, 520, 522, 524 and 526 are optionally mechanical buttons or mechanical button alternatives that are able to sense contact with, or depression of, such buttons to initiate corresponding action(s) on, for example, device 500. In some embodiments, selection of “menu” button 516 by a user navigates device 500 backwards in a currently-executing application or currently-displayed user interface (e.g., back to a user interface that was displayed previous to the currently-displayed user interface), or navigates device 500 to a one-higher-level user interface than the currently-displayed user interface. In some embodiments, selection of “home” button 518 by a user navigates device 500 to a main, home, or root user interface from any user interface that is displayed on device 500 (e.g., to a home screen of device 500 that optionally includes one or more applications accessible on device 500). In some embodiments, selection of the “home” button 518 causes the electronic device to navigate to a unified media browsing application. In some embodiments, selection of “play/pause” button 520 by a user toggles between playing and pausing a currently-playing content item on device 500 (e.g., if a content item is playing on device 500 when “play/pause” button 520 is selected, the content item is optionally paused, and if a content item is paused on device 500 when “play/pause” button 520 is selected, the content item is optionally played). In some embodiments, selection of “+” 522 or “−” 524 buttons by a user increases or decreases, respectively, the volume of audio reproduced by device 500 (e.g., the volume of a content item currently-playing on device 500). In some embodiments, selection of “audio input” button 526 by a user allows the user to provide audio input (e.g., voice input) to device 500, optionally, to a voice assistant on the device. In some embodiments, remote 510 includes a microphone via which the user provides audio input to device 500 upon selection of “audio input” button 526. In some embodiments, remote 510 includes one or more accelerometers for detecting information about the motion of the remote.

FIG. 5C depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

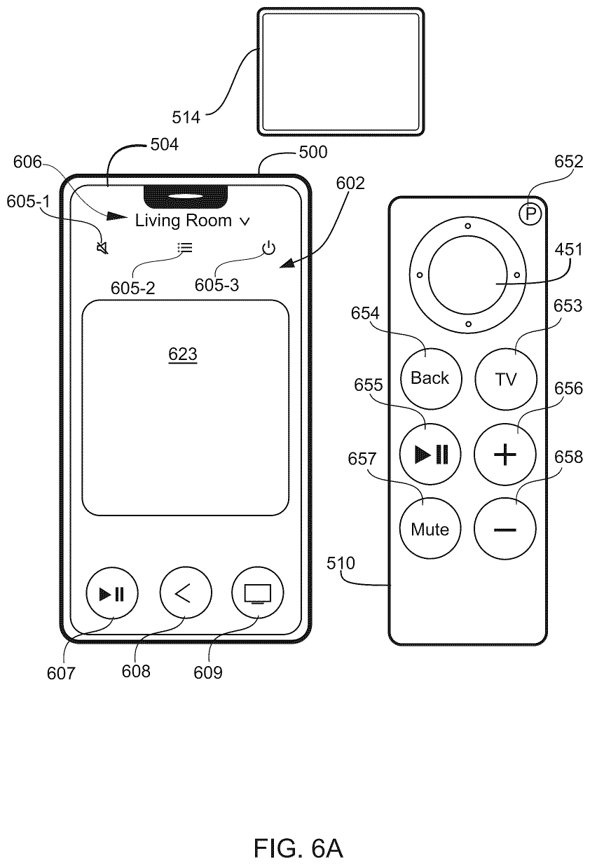

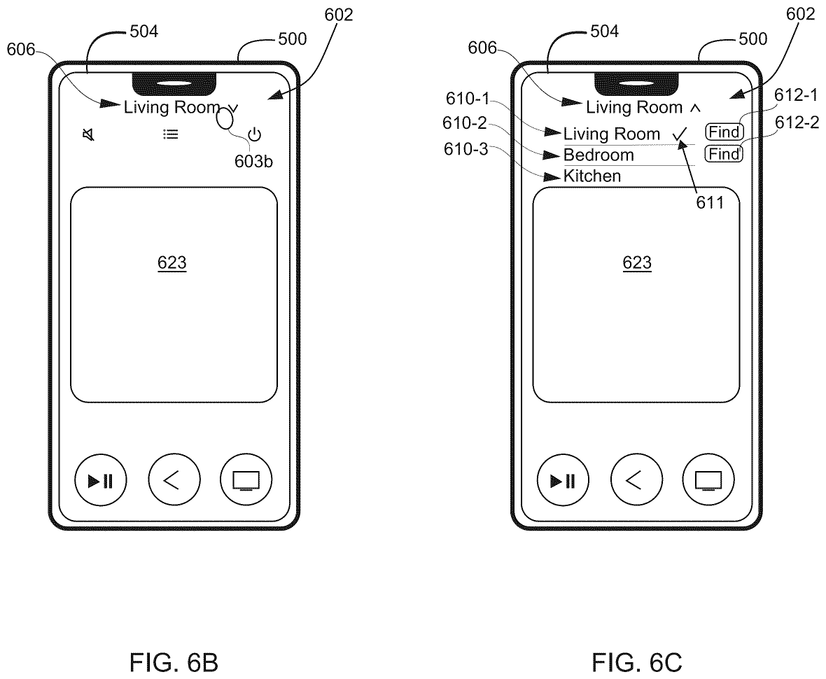

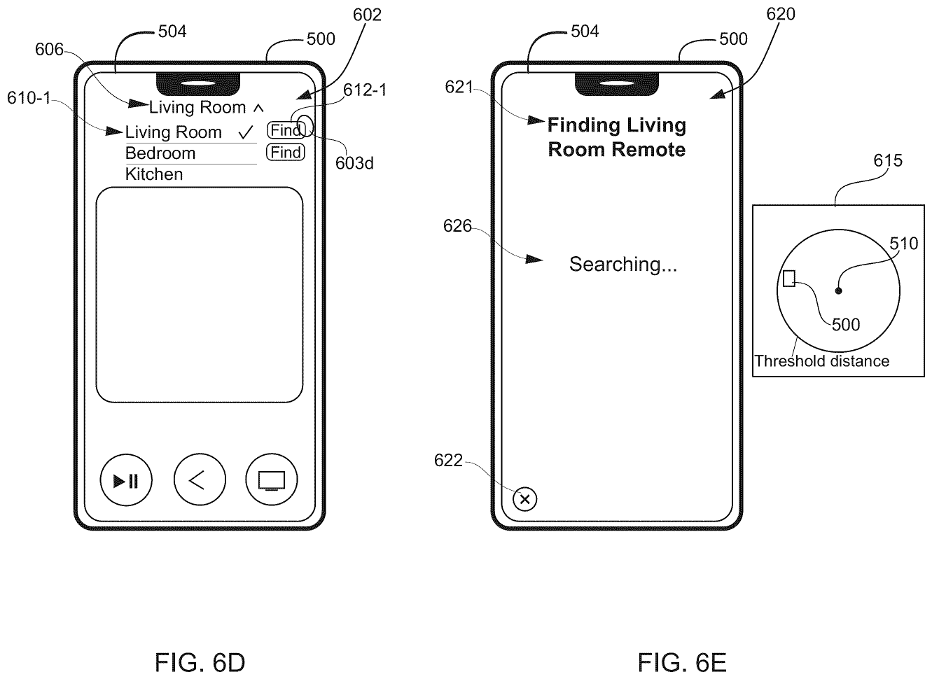

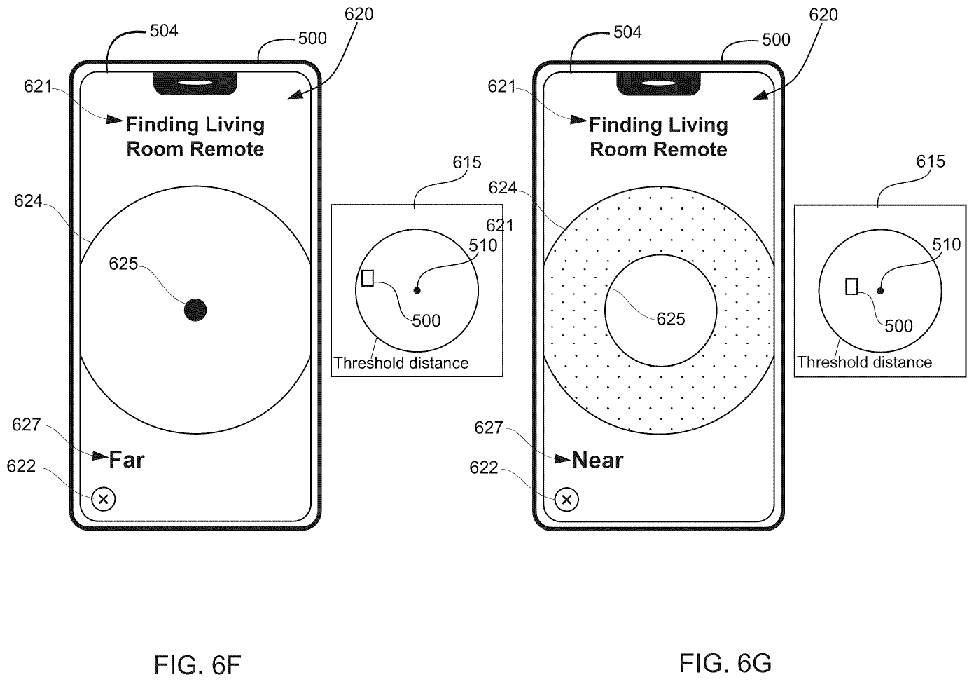

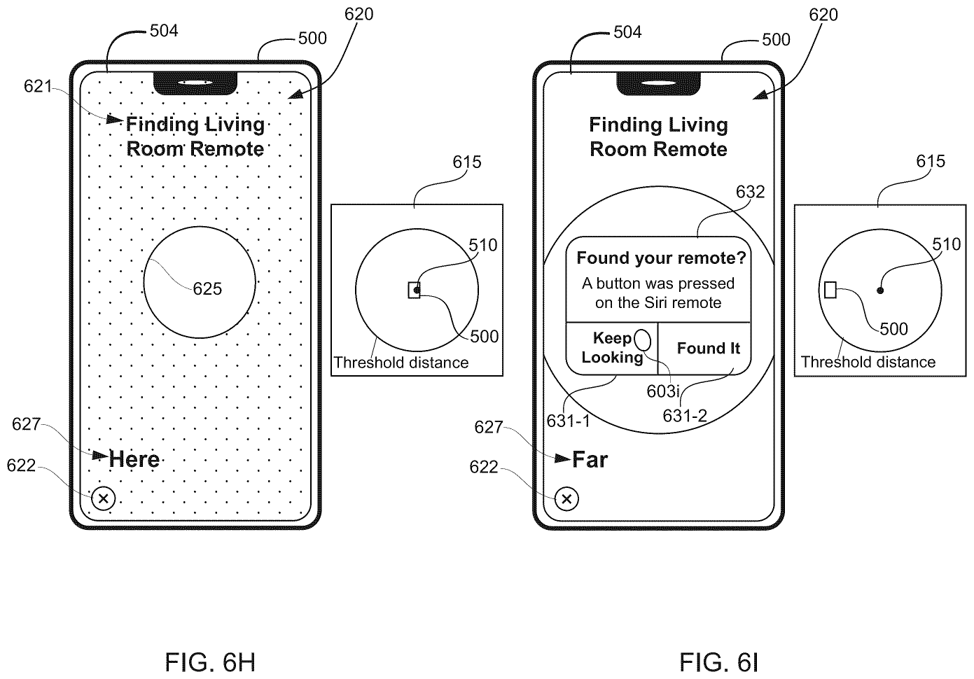

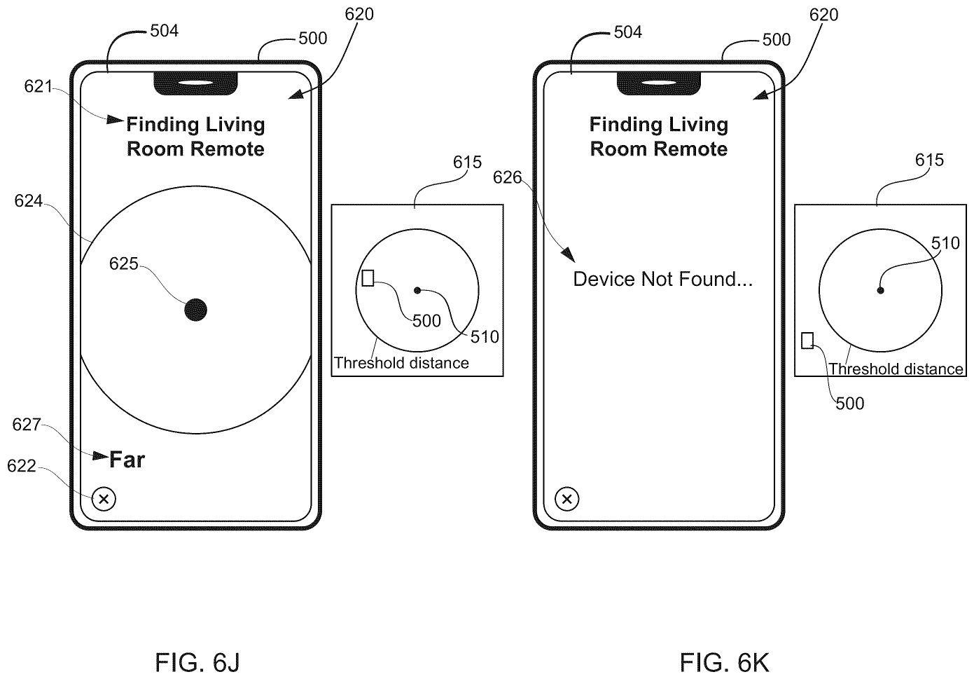

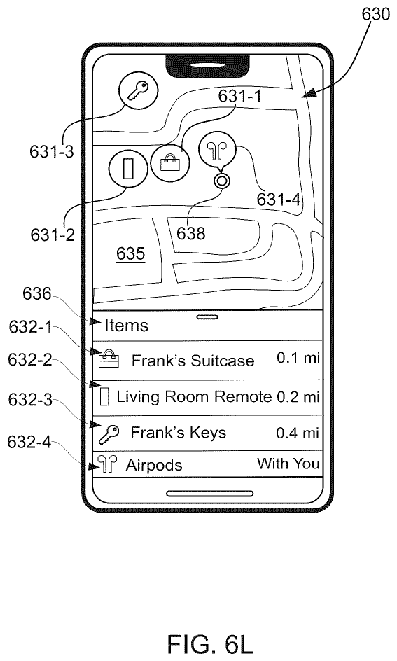

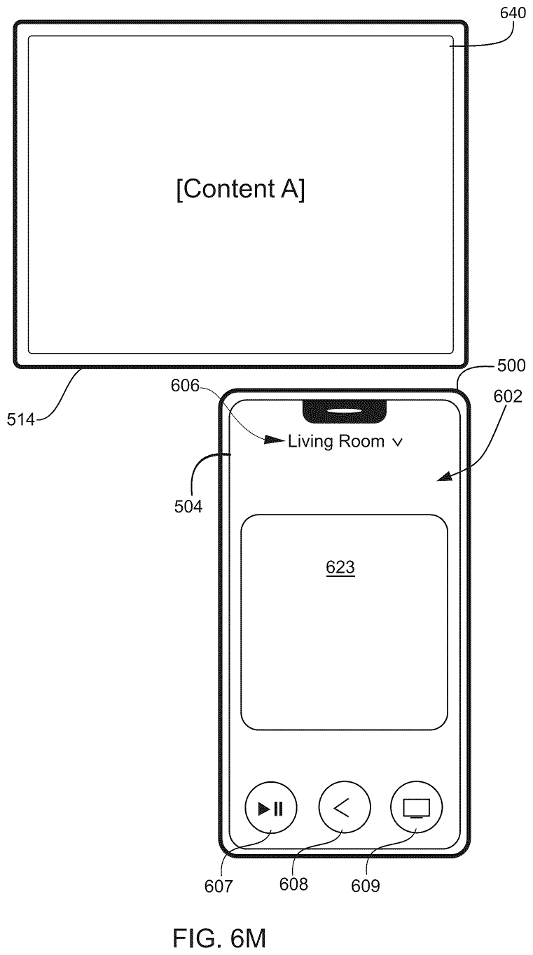

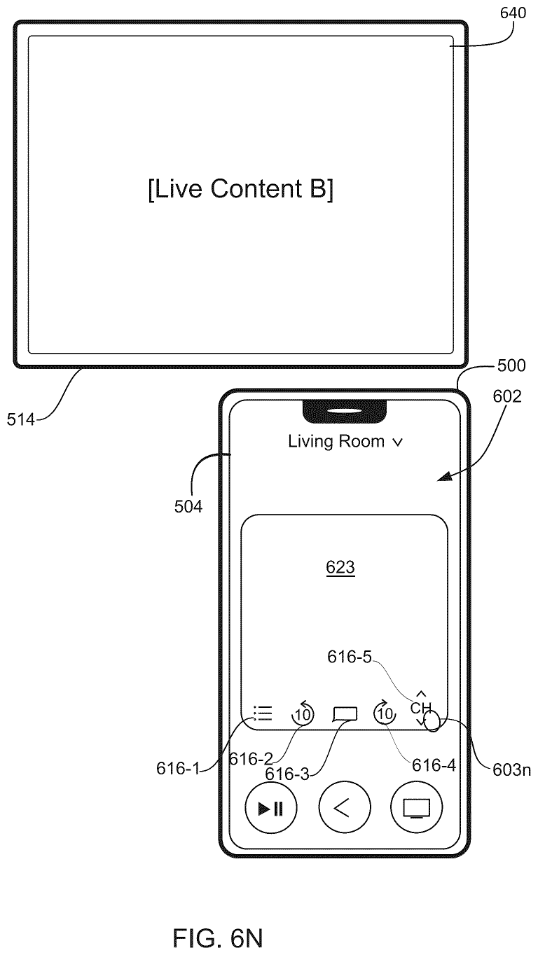

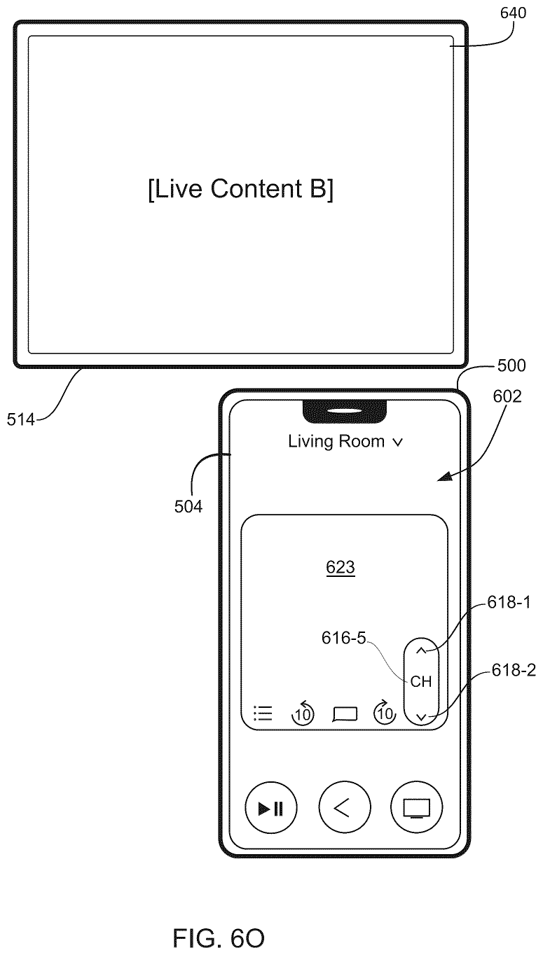

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes described with reference to FIGS. 6-11. A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5C, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

One or more of the embodiments disclosed herein optionally include one or more of the features disclosed in the following patent applications: “User Interfaces For Interacting with Channels that Provide Content that Plays in a Media Browsing Application” (Attorney Docket No.: 106843171600 (P42089USP1), filed Mar. 24, 2019), “User Interfaces For a Media Browsing Application” (Attorney Docket No.: 106843171700 (P42090USP1), filed Mar. 24, 2019), and “User Interfaces Including Selectable Representations of Content Items” (Attorney Docket No.: 106843171800 (P42091USP1), filed Mar. 24, 2019), each of which is hereby incorporated by reference.

Attention is now directed towards embodiments of user interfaces (“UI”) and associated processes that are implemented on an electronic device, such as portable multifunction device 100, device 300, or device 500.

### User Interfaces and Associated Processes

Interactions with a Remote-Control User Interface

Users interact with electronic devices in many different manners, including using an electronic device to locate and/or track a remote input device via a remote-control user interface. In some embodiments, an electronic device is configurable to display a remote-control user interface that is configured to control another electronic device, such as to control playback of a content item that is currently displayed in a playback user interface of the other electronic device. The embodiments described below provide ways in which a first electronic device facilitates finding of a remote-input device that is associated with a second electronic device via a remote-control user interface. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

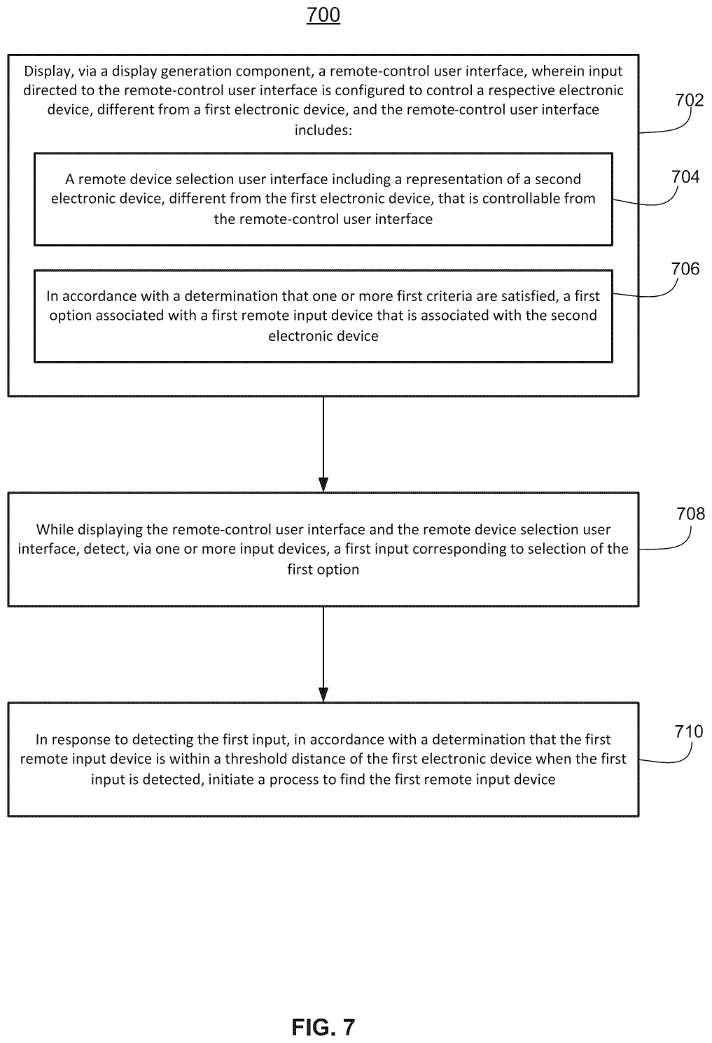

FIGS. 6A-6O illustrate exemplary ways in which a first electronic device facilitates finding of a remote input device that is associated with a second electronic device using a remote-control user interface in accordance with some embodiments of the disclosure. The embodiments in these figures are used to illustrate the processes described below, including the processes described with reference to FIG. 7.

FIGS. 6A-6L illustrate an electronic device 500 presenting user interfaces associated with remote-control of a second electronic device 514. FIG. 6A illustrates a remote-control user interface 602 (e.g., displayed via touchscreen 504 of the electronic device 500). In some embodiments, the remote-control user interface 602 is configurable to control a second electronic device, such as electronic device 514. For example, input directed to the remote-control user interface 602 is configured to be transmitted to the electronic device 514 to control one or more operations of the electronic device 514, such as playback of a content item being displayed by the electronic device 514, as discussed in more detail herein later.

In some embodiments, as shown in FIG. 6A, the electronic device 514 is associated with a remote input device 510. In some embodiments, as shown in FIG. 6A, the remote input device 510 includes a plurality of buttons (e.g., physical buttons) that is each selectable to cause the electronic device 514 to perform a respective operation. In some embodiments, as shown in FIG. 6A, the remote input device 510 includes a power button 652, which is selectable to power down the electronic device 514 and/or to cause the electronic device 514 to enter a sleep state. In some embodiments, as shown in FIG. 6A, the remote input device 510 includes touch-sensitive surface 451 that is configured to detect touch (e.g., from a contact) for providing selection inputs, scrolling inputs, etc. directed to a user interface displayed on the electronic device 514. In some embodiments, the touch-sensitive surface 451 includes physical navigation buttons (e.g., up, down, left, and right arrow keys) for performing similar functions. In some embodiments, the remote input device 510 includes a back button that is selectable to cause the electronic device 514 to navigate backward within a user interface and/or to display a previous user interface, a home button 653 that is selectable to cause the electronic device 514 to display a user interface of a media browsing application, and a playback button 655 that is selectable to, when displaying a content item, cause the electronic device 514 to pause and/or resume playback of the content item. Additionally, in some embodiments, as shown in FIG. 6A, the remote input device 510 includes a mute button 657 that is selectable to mute audio that is being output by the electronic device 514, a first volume button 656 that is selectable to increase a volume of audio being output by the electronic device 514, and a second volume button 658 that is selectable to decrease the volume of audio.

In some embodiments, as mentioned above, the remote-control user interface 602 is configurable to control one or more operations of the electronic device 514 in a same or similar fashion as the remote input device 510. For example, as shown in FIG. 6A, the remote-control user interface 602 includes a mute option 605-1 that is similar in function to the mute button 657 of the remote input device 510, a list option 605-2 that is selectable to display a list of options based on the particular user interface that is displayed by the electronic device 514, and a power option 605-3 that is similar in function to the power button 652 of the remote input device 510. Additionally, in some embodiments, as shown in FIG. 6A, the remote-control user interface 602 includes touch input region 623 that is similar in function to the touch-sensitive surface 451 of the remote input device 510. In some embodiments, as shown in FIG. 6A, the remote-control user interface 602 includes a playback option 607 that is similar in function to the playback button 655 of the remote input device 510, a back option 608 that is similar in function to the back button 654, and a home option 609 that is similar in function to the home button 653 of the remote input device 510.

In some embodiments, as shown in FIG. 6A, the remote-control user interface 602 includes user interface object 606 that indicates an electronic device that the remote-control user interface 602 is currently selected to control. For example, as shown in FIG. 6A, the user interface object includes text “Living Room” indicating that the remote-control user interface 602 is currently selected to control an electronic device that is associated with the name or title Living Room. In the example of FIG. 6A, the electronic device that is associated with the name or title Living Room corresponds to the electronic device 514. Accordingly, in FIG. 6A, the remote-control user interface 602 is currently selected to control the electronic device 514. In some embodiments, the user interface object 606 is selectable to display a list of electronic devices that the remote-control user interface 602 is configurable to control, as discussed below.

In FIG. 6B, while displaying the remote-control user interface 602, the electronic device 500 detects a selection of the user interface object 606. For example, as shown in FIG. 6B, the electronic device 500 detects a tap of contact 603b directed to the user interface object 606 on the touchscreen 504.

In some embodiments, as shown in FIG. 6C, in response to detecting the selection of the user interface object 606 in the remote-control user interface 602, the electronic device 500 displays a list of electronic devices that are configured to be controlled using the remote-control user interface 602. For example, as shown in FIG. 6C, the electronic device 500 displays a first representation 610-1 of a second electronic device (e.g., Living Room) that is configurable to be controlled via the remote-control user interface 602, a second representation 610-2 of a third electronic device (e.g., Bedroom) that is configurable to be controlled via the remote-control user interface 602, and a third representation 610-3 of a fourth electronic device (e.g., Kitchen) that is configurable to be controllable via the remote-control user interface 602. In some embodiments, as discussed above, the remote-control user interface 602 is currently configured to control the electronic device associated with the name or title Living Room, which corresponds to the electronic device 514 above. Accordingly, as shown in FIG. 6A, the first representation 610-1 is optionally displayed with visual indication 611 (e.g., a checkmark) indicating that the electronic device 514 is currently selected to be controlled via the remote-control user interface 602.

In some embodiments, as similarly discussed above, one or more of the electronic devices listed in the remote-control user interface 602 in FIG. 6C are associated with a remote input device. For example, as previously discussed above, the electronic device 514 in FIG. 6A is associated with (e.g., configured to be controlled by) the remote input device 510. In some embodiments, the remote input device 510 discussed above is a findable item. For example, the remote input device 510 is configured to be trackable by another electronic device, such as the electronic device 500 (e.g., via location information shared by the remote input device 510 and/or via a strength of a wireless signal output by the remote input device 510, such as a Bluetooth signal, a WiFi signal, etc.). In some embodiments, in accordance with a determination that a respective remote input device that is associated with an electronic device is a findable item, the representation of the electronic device in the remote-control user interface 602 includes a selectable option that is selectable to initiate a process to find/locate the respective remote input device. For example, as shown in FIG. 6C, because the remote input device 510 is a findable item as discussed above, the first representation 610-1 of the electronic device 514 is displayed with a first selectable option 612-1 (e.g., Find option) that is selectable to initiate a process to find the remote input device 510. Similarly, as shown in FIG. 6C, a second remote input device that is associated with the electronic device associated with the name or title Bedroom is a findable item, so the second representation 610-2 is displayed with a second selectable option 612-2 that is selectable to initiate a process to find the second remote input device. In some embodiments, in accordance with a determination that an electronic device is associated with a remote input device that is not findable (or the electronic device is not associated with a remote input device at all), the representation of the electronic device does not include a selectable option that is selectable to initiate a process to find the remote input device. For example, as shown in FIG. 6C, the electronic device associated with the name or title Kitchen is not associated with a remote input device that is a findable item. Accordingly, the third representation 610-3 is optionally not displayed with a selectable option (e.g., a Find option) in the remote-control user interface 602.

In FIG. 6D, while displaying the remote-control user interface 602, the electronic device 500 detects a selection of the first selectable option 612-1. For example, as shown in FIG. 6D, the electronic device 500 detects a tap of contact 603d directed to the first selectable option 612-1 on the touchscreen 504.

In some embodiments, as shown in FIG. 6E, in response to detecting the selection of the first selectable option 612-1 in the remote-control user interface 602, the electronic device 500 initiates a process to find the remote input device 510. In some embodiments, as shown in FIG. 6E, initiating the process to find the remote input device 510 includes displaying a finding user interface 620. In some embodiments, as shown in FIG. 6E, the finding user interface 620 includes a heading/title indication 621 (e.g., “Finding Living Room Remote”) that provides an indication of the remote input device that the electronic device 500 is currently locating/tracking (e.g., the remote input device 510), a status indication 626 (e.g., “Searching . . . ”) that provides an indication of whether the remote input device 510 is able to be tracked/located via the finding user interface 620, and an exit option 622 that is selectable to cease display of the finding user interface 620 and end the finding of the remote input device 510.

In some embodiments, determining whether the remote input device 510 is able to be tracked/located via the finding user interface 620 includes determining whether the remote input device 510 is within a threshold distance (e.g., 0.01, 0.05, 0.1, 0.5, 1, 1.5, 2, 3, 5, 10, etc. meters) of the current location of the electronic device 500. In some embodiments, as shown in legend 615 in FIG. 6E, the electronic device 500 determines that the remote input device 510 is within the threshold distance (e.g., “Threshold distance”) of the electronic device 500. Accordingly, the electronic device 500 determines that the remote input device 510 is able to be tracked/located via the finding user interface 620.

In some embodiments, as shown in FIG. 6F, in accordance with the determination that the remote input device 510 is within the threshold distance of the electronic device 500, the electronic device 500 updates display of the finding user interface 620 to include visual indicator 625 and a textual indication 627 of a relative distance between the remote input device 510 and the electronic device 500. In some embodiments, the visual indicator 625 is updated based on a change in distance between the electronic device 500 and the remote input device 510. For example, as discussed below, the visual indicator 625 grows/expands outward toward ring 624 as the distance between the electronic device 500 and the remote input device 510 decreases. Similarly, as discussed below, the textual indication 627 is updated based on a detected change in distance between the electronic device 500 and the remote input device 510. In some embodiments, the electronic device 500 determines a location of and/or a distance to the remote input device 510 based on a strength of a wireless connection (e.g., Bluetooth connection) between the electronic device 500 and the remote input device 510. For example, as the distance between the electronic device 500 and the remote input device 510 decreases, the strength of the Bluetooth connection between the electronic device 500 and the remote input device 510 increases. Additional details regarding the determination of the location of the remote input device 510 relative to the electronic device 500 are provided below with reference to method 700. In the example, of FIG. 6F, because the remote input device 510 is located close to the threshold distance from the electronic device 500, the textual indication 627 is displaying an indication of “Far” in the finding user interface 620.

In FIG. 6G, the electronic device 500 detects that the distance between the electronic device 500 and the remote input device 510 has decreased, as shown in the legend 615. For example, the user has moved and is now closer to the remote input device 510. In some embodiments, as shown in FIG. 6G, in response to detecting that the distance between the electronic device 500 and the remote input device 510 has decreased, the electronic device 500 updates the finding user interface 620. Particularly, as shown in FIG. 6G, the electronic device 500 updates the visual indicator 625 and the textual indication 627. As shown in FIG. 6G, the visual indicator 625 has increased in size relative to the ring 624 and the textual indication 627 provides an indication (e.g., “Near”) that the user is relatively close to the location of the remote input device 510.

In FIG. 6H, the electronic device 500 detects that the distance between the electronic device 500 and the remote input device 510 has decreased further, as shown in the legend 615. For example, the user has moved such that the electronic device 500 is now at or adjacent to the location of the remote input device 510. In some embodiments, as shown in FIG. 6H, in response to detecting that the distance between the electronic device 500 and the remote input device 510 has decreased, the electronic device 500 updates the finding user interface 620. Particularly, as shown in FIG. 6H, the electronic device 500 updates the visual indicator 625 and the textual indication 627. As shown in FIG. 6H, the visual indicator 625 has expanded and increased further in size relative to the ring 624, such that the visual indication 625 is occupying a significant portion (e.g., 50, 60, 70, 75, 80, etc. %) of the finding user interface 620, and the textual indication 623 has been updated to provide an indication (e.g., “Here”) that the user has arrived at the location of the remote input device 510. In some embodiments, as mentioned above, once the user locates the remote input device 510, the user is able to select the exit option 622 in the finding user interface 620 to end the finding of the remote input device 510 and cease display of the finding user interface 620.

In some embodiments, while finding the remote input device 510, in accordance with a determination that the remote input device 510 detects user interaction, the electronic device 500 displays, in the finding user interface 620, an indication of the user interaction. For example, in FIG. 6I, while the electronic device 500 is displaying the finding user interface 620 and is locating the remote input device 510, the electronic device 500 receives an indication (e.g., from the remote input device 510) that the remote input device 510 has detected user interaction. For example, the remote input device 510 detects a selection of one of the buttons of the remote input device 510, movement of the remote input device 510, a contact on the touch-sensitive surface 451 of the remote input device 510, etc. In some embodiments, as shown in FIG. 6I, in response to detecting the indication that the remote input device 510 has detected the user interaction, the electronic device 500 displays notification 632 informing the user that the remote input device 510 has detected the user interaction (e.g., a button press). As shown in FIG. 6I, the notification 632 prompts the user to confirm whether the user interaction was provided by the user and/or whether the user is aware of the user interaction directed to the remote input device 510. For example, as shown in FIG. 6I, the notification 632 includes a first option 631-1 that, when selected, indicates that the user has not found the remote input device 510, and a second option 631-2 that, when selected, indicates that the user has found the remote input device 510. In some embodiments, if the electronic device 500 detects a selection of the first option 631-1, the electronic device 500 maintains display of the finding user interface 620, and if the electronic device 500 detects a selection of the second option 631-2, the electronic device 500 ceases display of the finding user interface 620.

In FIG. 6I, while displaying the notification 632 in the finding user interface 620, the electronic device 500 detects a selection of the first option 631-1. For example, as shown in FIG. 6I, the electronic device 500 detects a tap of contact 603i directed to the first option 631-1 on the touchscreen.

In some embodiments, as show in FIG. 6J, in response to detecting the selection of the first option 631-1, the electronic device 500 maintains display of the finding user interface 620. For example, the selection of the first option 631-1 indicates to the electronic device 500 that the user has not found the remote input device 510 (and that the user interaction detected by the remote input device 510 was caused by an alternative source, such as a pet or another user).

In some embodiments, in response to detecting the selection of the first selectable option 612-1 in FIG. 6D, in accordance with a determination that the remote input device 510 is greater than the threshold distance from the electronic device 500, the electronic device 500 forgoes locating/finding the remote input device 510 via the finding user interface 620 in the manner discussed above. For example, as shown in FIG. 6K, in the legend 615, the remote input device 510 is more than the threshold distance from the electronic device 500. In some embodiments, as shown in FIG. 6K, in accordance with the determination that the remote input device 510 is greater than the threshold distance from the electronic device 500, the electronic device 500 updates the status indication 626 to provide an indication that the remote input device 510 is not findable via the finding user interface 620 (e.g., because the Bluetooth connection between the electronic device 500 and the remote input device 510 is too weak due to the remote input device 510 being more than the threshold distance from the electronic device 500).

In some embodiments, in accordance with the determination that the remote input device 510 is greater than the threshold distance from the electronic device 500, the electronic device 500 (e.g., automatically) launches an item finding application via which the electronic device 500 is able to track the location of the remote input device 510. In some embodiments, the electronic device 500 launches the item finding application in response to user input (e.g., after updating the status indication 626). For example, after providing the indication that the remote input device 510 is not findable via the finding user interface 620, the electronic device 500 detects an input for minimizing display of the finding user interface 620 (e.g., selection of exit option 622 or a swipe of a contact on the touchscreen 504), followed by an input for launching the item locating application (e.g., selecting an icon corresponding to the item locating application in a home screen user interface of the electronic device 500).

In some embodiments, as shown in FIG. 6L, launching the item locating application includes displaying a user interface 630 of the item locating application. In some embodiments, the user interface 630 of the item locating application displays information regarding one or more findable items the locations to which the user (e.g., Frank) of the electronic device 500 has access.

As shown in FIG. 6L, in some embodiments, the user interface 630 of the item locating application includes a list 636 of findable items to which the user (e.g., Frank) has access to the locations thereof. For example, as shown in FIG. 6L, the list 636 (titled “Items”) includes findable items (e.g., remote locator objects or other trackable objects) that are owned by the user, such as Frank's Suitcase in first item 632-1, Living Room Remote (e.g., corresponding to the remote input device 510 discussed above) in second item 632-2, Frank's Keys in third item 632-3, and Airpods in fourth item 632-4. As shown in FIG. 6L, the findable items of the list 636 optionally include graphical representations corresponding to the particular findable item, such as graphical representation of a suitcase for Frank's Suitcase in 632-1 and graphical representation of a key for Frank's Keys in 632-3.

In some embodiments, the user interface 630 of the item locating application includes one or more distance indications that indicate the distance the items of list 636 are from the electronic device 500 (and thus from the user). In some embodiments, the one or more distance indications are optionally accompanied by a time indication that indicates when a particular distance indication was last updated. For example, as shown in FIG. 6L, in the user interface 630, first item 632-1 of list 636 indicates that findable item Frank's Suitcase is approximately 0.1 miles from the current location of the electronic device 500. Further, in FIG. 6L, second item 632-2 of list 636 indicates that findable item Living Room Remote is 0.2 miles from the current location of the electronic device 500, third item 632-3 of list 636 indicates that findable item Frank's Keys is approximately 0.4 miles from the current location of the electronic device 500, and fourth item 632-4 indicates that findable item Airpods is “With You” (e.g., at the current location of the user). In some embodiments, the location of the findable items is alternatively provided as an address. In some embodiments, a given item in list 636 does not include an indication of a distance of the corresponding findable item when that findable item is indicated as being “With You” (e.g., is within a threshold distance of electronic device 500, such as 0.1, 0.5, 1, 5, 10, or 100 meters).

In some embodiments, the user interface 630 of the item locating application in FIG. 6L includes a representation of a map 635 of a physical region surrounding and/or including the location of the user (e.g., Frank) and/or the electronic device 500. In some embodiments, the map 635 indicates the location 638 of the user (e.g., Frank) and/or the electronic device 500 as a circle, the locations of the findable items (e.g., including remote locator objects) of list 636, such as a representation of Frank's Suitcase (icon 631-1) at a location on the map 635 corresponding to the location of Frank's Suitcase in the physical region, a representation of Frank's Keys (icon 631-3) at a location on the map 635 corresponding to the location of Frank's Keys, a representation of Living Room Remote (icon 631-2) at a location on the map 635 corresponding to the location of Living Room Remote, and a representation of Airpods (icon 631-4) at a location on the map corresponding to the location of Airpods, and/or locations of additional users that share their location with the user (e.g., Frank). As shown in the example of FIG. 6L, no additional users are currently sharing their locations with Frank and thus, no additional user is displayed on the map in the user interface 630. As further shown in FIG. 6A, and as noted above, the representations 631-1, 631-2, 631-3, and 631-4 indicate the corresponding findable item (e.g., a graphic of the corresponding findable item) such that the user (e.g., Frank) can visually identify the findable item on the map 635 of the user interface 630. In some embodiments, and as shown in FIG. 6L, the representations of the findable items on the map 635 of the user interface 630 are bubbles and/or circles including the graphics discussed above. However, it should be understood that the representations are optionally any shape and/or size. In some embodiments, and as shown in FIG. 6L, the representation 631-4 of the findable item Airpods and the current location 638 of the user/electronic device 500 are stacked on map 635 of the user interface 630 because the current location of the user and the findable item Airpods are in close proximity.

In some embodiments, as mentioned above, the user of the electronic device 500 is able to track the location of the remote input device 510 discussed above via the user interface 630 of the item locating application. For example, additional location information for the remote input device 510 is displayed in response to the electronic device 500 detecting a selection of the representation 631-2 of the Living Room Remote and/or a selection of the second item 632-2 in the list 636 of findable items. In some embodiments, the electronic device 500 displays a selectable option that is selectable to display a finding user interface associated with the item locating application for finding the remote input device 510 or displays a maps user interface associated with a maps application for navigating to the location of the remote input device 510.

FIGS. 6M-6O illustrate an electronic device 514 presenting a playback user interface associated with displaying content items and that is controllable via a remote-control user interface displayed by a second electronic device 500. FIG. 6M illustrates a playback user interface 640 (e.g., displayed via a display of the electronic device 514). As shown in FIG. 6M, the playback user interface 640 is optionally displaying an on-demand content item (“Content A”). In some embodiments, the on-demand content item corresponds to a movie, an episode of a television show, etc. that is available for playback in the playback user interface 640 via streaming and/or purchase/rent. Additional examples of on-demand content items that can be displayed in the playback user interface 640 are provided below with reference to method 700.

In some embodiments, as shown in FIG. 6M, the electronic device 500 is displaying, via touchscreen 504, remote-control user interface 602 discussed previously above. In some embodiments, the remote-control user interface 602 is currently selected to control one or more operations of the electronic device 514, as indicated by the user interface object 606 (e.g., as discussed previously above, the electronic device 514 is associated with the name or title Living Room). For example, input detected via the remote-control user interface 602 is directed as input to the playback user interface 640 displayed by the electronic device 514.

In some embodiments, the electronic device 500 selectively displays a respective set of playback controls in the remote-control user interface 602 based on the type of content that is being played back in the playback user interface 640 at the electronic device 514. In some embodiments, in accordance with a determination that the content being played back in the playback user interface 640 is an on-demand content item, the electronic device 500 forgoes displaying the respective set of playback controls in the remote-control user interface 602. In some embodiments, the electronic device displays a subset of the respective set of playback controls, but not all controls in the respective set of playback controls. As shown in FIG. 6M, because the electronic device 514 is displaying an on-demand content item in the playback user interface 640, the electronic device 500 forgoes displaying the respective set of playback controls in the remote-control user interface 602. In some embodiments, as similarly discussed below, if the subset of the respective set of playback controls is displayed, the subset is displayed overlaid on the touch input region 623 in the remote-control user interface 602.

In FIG. 6N, the electronic device 514 is alternatively displaying a live content item (e.g., Live Content B) in the playback user interface 640 discussed above. In some embodiments, the live content item corresponds to a live-broadcast content item that is being broadcast to the electronic device 514 via a respective media provider of the live-broadcast content item. For example, the live content item corresponds to a sports game, a movie, a television show, a news program, or other content that is not available for playback at the electronic device 514 until it is broadcast/streamed by the respective media provider for consumption at the electronic device 514. Additional examples of live content items that can be displayed in the playback user interface 640 are provided below with reference to method 700.

In some embodiments, in accordance with a determination that the content being played back in the playback user interface 640 at the electronic device 514 is a live content item, the electronic device 500 displays the respective set of playback controls in the remote-control user interface 602. As discussed above, the electronic device 514 is displaying a live content item in the playback user interface 640, so the electronic device 500 displays playback controls 616-1 to 616-5 overlaid on the touch input region 623 in the remote-control user interface 602. In some embodiments, a first playback control 616-1 is selectable to display a list of options that is specific to the playback user interface 640, such as a navigation guide, a list of channels, etc. associated with the media provider application of the playback user interface 640. In some embodiments, a second playback control 616-2 is selectable to rewind the live content item (e.g., by a predefined amount, such as 5, 10, 15, 30, etc. seconds), a third playback control 616-3 is selectable to initiate display of subtitles or other closed captions associated with the live content item, and a fourth playback control 616-4 is selectable to fast forward the live content item (e.g., by the predefined amount) in the playback user interface 640. Additionally, as shown in FIG. 6N, the respective set of playback controls includes a fifth playback control 616-5 (e.g., a channel navigation control) that is selectable to initiate a process for navigating through channels (e.g., media providers) in the playback user interface 640.

In FIG. 6N, while displaying the respective set of playback controls in the remote-control user interface 602, the electronic device 500 detects a selection of the fifth playback control 616-5. For example, as shown in FIG. 6N, the electronic device 500 detects a tap of contact 603n directed to the fifth playback control 616-5 on the touchscreen 504.

In some embodiments, as shown in FIG. 6O, in response to detecting the selection of the fifth playback control 616-5, the electronic device 500 updates display of the fifth playback control 616-5 to include individually selectable up and down keys 618-1 and 618-2. For example, as shown in FIG. 6O, the electronic device 500 expands/increases a size of the fifth playback control 616-5 to enable the up and down keys of the fifth playback control 616-5 to be more easily selectable. In some embodiments, the up key 618-1 is selectable to navigate upward through the list of channels associated with the playback user interface 640 and the down key 618-2 is selectable to navigate downward through the list of channels.

FIG. 7 is a flow diagram illustrating a method of facilitates finding of a remote input device that is associated with a second electronic device using a remote-control user interface in accordance with some embodiments. The method 700 is optionally performed at an electronic device such as device 100, device 300, or device 500 as described above with reference to FIGS. 1A-1B, 2-3, 4 and 5A-5C. Some operations in method 700 are, optionally combined and/or order of some operations is, optionally, changed.

As described below, the method 700 provides ways to facilitate efficient finding of a remote input device using a remote-control user interface. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 700 is performed by a first electronic device (e.g., electronic device 500) in communication with a display generation component and one or more input devices (e.g., touchscreen 504). For example, the first electronic device is a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the first electronic device has one or more characteristics of portable multifunction device 100 described with reference to FIG. 2 and/or device 511 described with reference to FIG. 5A.

In some embodiments, the first electronic device displays (702), via the display generation component, a remote-control user interface (e.g., remote-control user interface 602 in FIG. 6A), wherein input directed to the remote-control user interface is configured to control a respective electronic device, different from the first electronic device, such as electronic device 514 in FIG. 6A. In some embodiments, the respective electronic device is a mobile device, such as a smartphone, tablet, wearable device, a media player, set-top box, etc., that is configured to communicate with the first electronic device. In some embodiments, the respective electronic device includes a second display generation component that is integrated with the respective electronic device, such as a monitor, projector, or television. In some embodiments, the respective electronic device has one or more characteristics of the first electronic device. In some embodiments, the remote-control user interface includes a plurality of controls, in the form of selectable and/or interactive options/elements, for providing input to the respective electronic device. For example, selection of a respective option in the remote-control user interface causes the first electronic device to transmit input data that is received to the respective electronic device, which causes the respective electronic device to perform a respective operation associated with the respective option. In some embodiments, the plurality of controls includes one or more playback controls. For example, the respective electronic device is configured to display and/or is displaying a user interface, such as a media browsing user interface, a media player user interface, a playback user interface, etc. that is configured to present content (e.g., visual and/or audio content, such as movies, episodes of television shows, music, podcasts, audiobooks, video clips, etc.). In some such embodiments, the one or more playback controls of the remote-control user interface are configured to control playback of content that is being displayed and/or played back via the user interface displayed by the respective electronic device. For example, the one or more playback controls enable the user of the first electronic device to pause, fast-forward, and/or rewind the content, select viewing options for the content, and/or cease display of the content (e.g., and/or initiate a process for selecting different content item for display/playback). In some embodiments, the remote-control user interface is displayed via a touchscreen of the first electronic device. In some embodiments, the remote-control user interface includes a touch input region that is configured to receive touch input for navigating within a user interface that is displayed or is configured to be displayed via the respective electronic device. For example, a swipe gesture detected in the touch input region of the remote-control user interface displayed at the first electronic device is received as a directional input (e.g., a swipe input) at the respective electronic device for moving a current focus in the user interface and/or scrubbing through a respective content item being played back in the user interface. In some embodiments, the remote-control user interface provides a same or similar functionality as a physical remote controller in communication with the respective electronic device, such as remote 510 described with reference to FIG. 5B. For example, a plurality of the controls of the remote-control user interface are also provided (e.g., in a same or similar fashion) as the controls of the physical remote controller. In some embodiments, the remote-control user interface is configured to be displayed at the first electronic device while the respective electronic device is actively displaying content, such as via a user interface (e.g., one of the user interfaces discussed above).

In some embodiments, the remote-control user interface includes a remote device selection user interface including a representation of a second electronic device (e.g., representation 610-1 in FIG. 6C), different from the first electronic device, that is controllable from the remote-control user interface (704) (e.g., in a similar manner as discussed above with reference to the control of the respective electronic device). In some embodiments, the second electronic device corresponds to the respective electronic device discussed above. In some embodiments, the remote device selection user interface is displayed as a drop-down menu within the remote-control user interface. For example, the remote-control user interface includes a selectable affordance (e.g., an arrow or carrot affordance) that, when selected, causes the first electronic device to display the remote device selection user interface. In some embodiments, the remote device selection user interface includes one or more representations of one or more electronic devices, including the representation of the second electronic device, that are controllable from the remote-control user interface. In some embodiments, the remote device selection user interface includes a visual indication (e.g., a checkmark, an “X”, or other indication) that indicates which electronic device of the one or more electronic devices that is currently being controlled from the remote-control user interface. For example, the second electronic device is currently selected as being controllable from the remote-control user interface, so the representation of the second electronic device is displayed with the visual indication. In some embodiments, the representation of the second electronic device includes a textual indication of a name or other title of the second electronic device that enables the second electronic device to be readily identifiable by the user. For example, the name/title of the second electronic device indicates a type and/or a location of the second electronic device (e.g., within a home of the user, such as “Device A” and/or “Living Room”). In some embodiments, the name of the second electronic device is selected by a user of the second electronic device (e.g., such as the user of the first electronic device). In some embodiments, the representation of the second electronic device includes an image (e.g., a picture, a cartoon, a sketch, a schematic, etc.) corresponding to the second electronic device.

In some embodiments, the remote-control user interface includes, in accordance with a determination that one or more first criteria are satisfied, a first option associated with a first remote input device (e.g., a physical remote controller, as similarly discussed above) that is associated with the second electronic device (706), such as first selectable option 612-1 in FIG. 6C that is associated with remote input device 510 in FIG. 6A. For example, the second electronic device is controllable via one or more physical buttons/controls of the first remote input device (e.g., a remote similar to remote 510 described with reference to FIG. 5B). In some embodiments, the one or more first criteria include a criterion that is satisfied when the first remote input device that is associated with the second electronic device is a “findable” item. For example, the first remote input device includes a battery, one or more wireless antenna and a processor that enables the first remote input device to be trackable (e.g., locatable) by another electronic device, such as the first electronic device. In some embodiments, the first remote input device is configured to transmit location data of the first remote input device to the first electronic device (e.g., wirelessly, such as over Bluetooth, RF, IR, NFC, or Wi-Fi). In some embodiments, the first remote input device transmits the location data to the first electronic device if the first electronic device detects a selection of the first option, as discussed in more detail below. In some embodiments, in accordance with a determination that the one or more first criteria are not satisfied (e.g., because the first remote input device is not a findable item), the remote-control user interface does not include the first option associated with the first remote input device that is associated with the second electronic device (but still includes the remote device selection user interface discussed above). In some embodiments, if the remote device selection user interface includes a representation of a third electronic device, different from the first electronic device and the second electronic device, that is controllable from the remote-control user interface, and the one or more first criteria for the third electronic device are satisfied, the remote-control user interface includes a second option associated with a second remote input device (e.g., a trackable physical remote controller) that is associated with the third electronic device, optionally different from the remote input device that is associated with the second electronic device. In some embodiments, if the one or more first criteria for the third electronic device are not satisfied, the remote-control user interface does not include the second option. In some embodiments, while the remote-control user interface is configured to control the second electronic device, the second option associated with the second remote input device is still selectable within the remote-control user interface to initiate finding of the second remote input device, as discussed below. For example, the remote-control user interface need not be currently set to control a particular electronic device that is associated with a remote input device to enable the first electronic device to find the remote input device.

In some embodiments, while displaying the remote-control user interface and the remote device selection user interface, the first electronic device detects (708), via the one or more input devices, a first input corresponding to selection of the first option, such as a tap of contact 603d on the touchscreen 504 directed to the first selectable option 612-1 as shown in FIG. 6D. For example, the first electronic device receives a tap detected on a touch-sensitive surface of the one or more input devices (e.g., on a remote input device in communication with the first electronic device), such as touch sensitive surface 451 described with reference to FIG. 4, a click of the touch-sensitive surface, or a selection of a hardware button of a remote input device in communication with the first electronic device, such as remote 510 described with reference to FIG. 5B (optionally while the first option has a current focus in the remote-control user interface). In some embodiments, the first input is detected via a touch screen of the first electronic device (e.g., the touch screen is integrated with the first electronic device, and is the display via which the remote-control user interface is being displayed) at a location corresponding to the first option. For example, the electronic device detects a tap or touch provided by an object (e.g., a finger of the user or a hardware input device, such as a stylus) via the touch screen directed to the first option.

In some embodiments, in response to detecting the first input, in accordance with a determination that the first remote input device is within a threshold distance (e.g., 0.01, 0.05, 0.1, 0.5, 0.75, 1, 2, 5, 10, 15, 20, or 30 meters) of the first electronic device when the first input is detected, such as “Threshold distance” in legend 615 in FIG. 6E, the first electronic device initiates (710) a process to find the first remote input device, such as display of finding user interface 620 as shown in FIG. 6E. For example, in response to detecting the first input, the first electronic device transmits a request (e.g., directly to the first remote input device or indirectly via a server (e.g., a wireless communications terminal) in communication with the first electronic device and the first remote input device)) for location information from the first remote input device to enable the first electronic device to track the location of the first remote input device. In some embodiments, initiating the process to find the first remote input device includes displaying, via the display generation component, a finding user interface that utilizes a proximity finding feature for locating the first remote input device, as discussed in more detail below. For example, the first electronic device replaces display of the remote-control user interface with the finding user interface. In some embodiments, initiating a process to find the remote input device includes utilizing a Bluetooth (or other wireless signal, such as Wi-Fi) proximity feature. For example, as discussed in more detail below, the first electronic device determines a location of the first remote input device and/or a direction of the first remote input device relative to the first electronic device based on a strength of the Bluetooth connection between the first electronic device and the first remote input device (e.g., the strength of the Bluetooth connection increases as the distance between the first electronic device and the first remote input device decreases). In some embodiments, in accordance with a determination that the first remote input device is outside the threshold distance of the first electronic device when the first input is detected, the first electronic device forgoes initiating the process to find the first remote input device. Initiating a process to find a remote input device that is associated with a second electronic device in response to detecting a selection of a first option in a remote-control user interface that is displayed at a first electronic device enables the user of the first electronic device to track the location of the remote input device, thereby improving user-device interaction and enabling the user to more quickly and accurately determine the location of the remote input device.

In some embodiments, satisfaction of the one or more first criteria is based on a determination that a respective remote input device (e.g., such as the first remote input device above) that is associated with a respective electronic device is a findable item, as similarly described with reference to FIG. 6C. For example, as similarly discussed above with reference to steps 702-710, the one or more first criteria are satisfied if the first remote input device is a trackable device and/or is a device for which location information is known by the first electronic device or is configured to be shared with the first electronic device. In some embodiments, the determination that the respective remote input device is a findable item is based on a wireless connection (e.g., Bluetooth connection, Wi-Fi connection, or other Internet Protocol) between the first electronic device and the respective remote input device. For example, the respective remote input device is in communication with the first electronic device (and/or has capabilities to be in communication with the first electronic device), which enables the first electronic device to determine an approximate location of the respective remote input device relative to the first electronic device, or the respective remote input device is configured to establish a connection with the first electronic device (e.g., in response to selection of the first selectable option discussed above with reference to steps 702-710). Accordingly, in some embodiments, if the respective remote input device, such as the first remote input device, is not a findable item based on the above-discussed requirements, the one or more first criteria are not satisfied. Initiating a process to find a trackable remote input device that is associated with a second electronic device in response to detecting a selection of a first option in a remote-control user interface that is displayed at a first electronic device enables the user of the first electronic device to track the location of the remote input device, thereby improving user-device interaction and enabling the user to more quickly and accurately determine the location of the remote input device.

In some embodiments, the remote-control user interface includes a first user interface object indicating a respective electronic device that the remote-control user interface is currently selected to control, such as user interface object 606 in FIG. 6A. For example, the first user interface object includes a textual indication of the respective electronic device that the remote-control user interface is currently selected to control. As an example, if the remote-control user interface is currently selected to control the second electronic device discussed above with reference to steps 702-710, the first user interface object includes an indication of a name or title (or other indication) of the second electronic device. In some embodiments, the first user interface object is displayed with a carrot or arrow affordance that indicates the first user interface object is selectable in the remote-control user interface.

In some embodiments, the remote device selection user interface (e.g., and the representation of the second electronic device) is displayed in the remote-control user interface in response to detecting a selection of the first user interface object, such as tap of contact 603b on the touchscreen 504 directed to the user interface object 606 as shown in FIG. 6B. For example, before displaying the remote device selection user interface discussed above with reference to steps 702-710, the first electronic device detects, via the one or more input devices, a selection of the first user interface object, such as the selection input discussed above. In some embodiments, in response to detecting the selection of the first user interface object, the first electronic device displays the remote device selection user interface that includes the representation of the second electronic device. Additionally, in some embodiments, when the first electronic device displays the remote device selection user interface, the first electronic device maintains display of the first user interface object. In some embodiments, while displaying the remote device selection user interface, if the first electronic device detects a subsequent selection of the first user interface object, the first electronic device ceases display of the remote device selection user interface in the remote-control user interface. Displaying a remote device selection user interface from which a particular electronic device is able to be designated for control in response to detecting a selection of a first user interface object in a remote-control user interface facilitates discovery that other electronic devices are able to be controlled via the remote-control user interface and/or reduces the number of inputs needed to track the location of a remote input device associated with one of the electronic devices, thereby improving user-device interaction and enabling the user to more quickly and accurately determine the location of the remote input device.

In some embodiments, the remote-control user interface is currently selected to control the second electronic device (e.g., electronic device 514 in FIG. 6A), as similarly described with reference to FIG. 6C. For example, as similarly discussed above with reference to steps 702-710, the remote-control user interface includes a plurality of controls, in the form of selectable and/or interactive options/elements, for providing input to the second electronic device. In some embodiments, the remote-control user interface is selected to control the second electronic device in response to detecting a selection of the representation of the second electronic device in the remote-control user interface, such as via a selection input as similarly discussed above with reference to steps 702-710. In some embodiments, the remote-control user interface is automatically selected to control the second electronic device when the remote-control user interface is initially displayed at the first electronic device (e.g., due to a proximity of the first electronic device to the second electronic device and/or based on user activity (e.g., previous user activity including interaction with the second electronic device).

In some embodiments, the representation of the second electronic device is displayed with (e.g., adjacent to) a visual indication (e.g., visual indication 611 in FIG. 6C) that the remote-control user interface is currently selected to the control the second electronic device. For example, the first electronic device displays a checkmark, bubble, “X”, or other visual indication with the representation of the second electronic device. In some embodiments, if the first electronic device detects a selection of a representation of a third electronic device, different from the second electronic device, in the remote-control user interface, the first electronic device moves the visual indication to be displayed with (e.g., beside) the representation of the third electronic device indicating that the remote-control user interface has been selected to control the third electronic device. Displaying a remote device selection user interface from which a particular electronic device is able to be designated for control, which is indicated via a visual indication, in response to detecting a selection of a first user interface object in a remote-control user interface facilitates visual discovery that other electronic devices are able to be controlled via the remote-control user interface and/or reduces the number of inputs needed to track the location of a remote input device associated with one of the electronic devices, thereby improving user-device interaction and enabling the user to more quickly and accurately determine the location of the remote input device.

In some embodiments, the remote device selection user interface further includes a representation of a third electronic device (e.g., such as the third electronic device discussed above), different from the first electronic device and the second electronic device, such as representation 610-2 in FIG. 6C, that is controllable from the remote-control user interface. In some embodiments, the representation of the third electronic device has one or more characteristics of the representation of the second electronic device, but specific to the third electronic device. In some embodiments, the third electronic device is a mobile device or a television.

In some embodiments, the remote-control user interface further includes, in accordance with a determination that one or more second criteria are satisfied (e.g., optionally the same as the one or more first criteria, but with respect to the third electronic device and/or the second remote input device) (e.g., because the second remote input device is a findable item, as similarly discussed above), a second option (e.g., second selectable option 612-2 in FIG. 6C) associated with a second remote input device (e.g., a physical remote controller, as similarly discussed above), different from the first remote input device, that is associated with the third electronic device. In some embodiments, the second option is the same or similar to the first option discussed above, but its functionality and interactivity is specific to the second remote input device. For example, the second option is selectable to initiate a process to find the third electronic device. In some embodiments, if the remote-control user interface includes a representation of a fourth electronic device that is controllable from the remote-control user interface, and the fourth electronic device does not satisfy one or more third criteria (e.g., optionally the same as the one or more first criteria, but with respect to the fourth electronic device and/or a remote input device of the fourth electronic device), because a third remote input device associated with the fourth electronic device is not a findable item, as similarly discussed above, the remote-control user interface does not include an option for initiating finding of the third remote input device that is associated with the fourth electronic device. Selectively displaying a selectable option that is associated with a remote input device in a remote-control user interface based on whether the remote input device is a findable item provides a visual indication of whether the location of the remote input device is able to be tracked and/or enables the user to track the location of the remote input device, thereby improving user-device interaction and enabling the user to more quickly and accurately determine the location of the remote input device.

In some embodiments, initiating the process to find the first remote input device includes displaying, via the display generation component, a finding user interface, such as finding user interface 620 in FIG. 6F. For example, the first electronic device replaces display of the remote-control user interface with the finding user interface. In some embodiments, the finding user interface is associated with the same application as the remote-control user interface, such as a remote-control application running on the first electronic device. In some embodiments, the finding user interface is a sub-user interface of the remote-control user interface. In some embodiments, the finding user interface includes one or more user interface elements that visually guide the user of the first electronic device in a direction of the first remote input device relative to the first electronic device (e.g., via an arrow indicating the relative location of the first remote input device relative to the first electronic device). In some embodiments, as discussed above with reference to steps 702-710, the first electronic device utilizes a wireless signal connection (e.g., Bluetooth connection) between the first electronic device and the first remote input device to assess a relative distance and/or direction of the first remote input device based on a strength of the wireless signal connection (e.g., the closer the first remote input device, the stronger the Bluetooth connection). Additional details regarding the finding user interface are provided below. In some embodiments, initiating the process to find the first remote input device includes launching an item locating application (e.g., displaying a user interface of the item locating application), and displaying a finding user interface in the item locating application. In some embodiments, the user interface of the item locating application includes one or more user interface elements that enable the user of the first electronic device to track and/or locate (e.g., navigate to) the first remote input device. Additional details regarding the item locating application are provided below. Displaying a finding user interface for locating a remote input device that is associated with a second electronic device in response to detecting a selection of a first option in a remote-control user interface that is displayed at a first electronic device enables the user of the first electronic device to track the location of the remote input device, thereby improving user-device interaction and enabling the user to more quickly and accurately visually determine the location of the remote input device.

In some embodiments, the finding user interface includes a first visual indicator that visually indicates a distance of the first remote input device relative to the first electronic device, such as visual indicator 625 as shown in FIG. 6F. For example, the first electronic device displays a bubble-shaped and/or circular/spherical affordance that visually grows/expands as a distance between the first electronic device and the first remote input device decreases. In some embodiments, the first visual indicator is displayed at and/or occupies a center position of the finding user interface. In some embodiments, when the finding of the first remote input device is first initiated, the first visual indicator is displayed as a dot or circle at the center position in the finding user interface. In some embodiments, as the distance between the first electronic device and the first remote input device decreases (e.g., as the strength of the Bluetooth connection between the first electronic device and the first remote input device increases), the first visual indicator grows/expands to occupy a greater portion of the finding user interface. In some embodiments, when the first electronic device detects that the location of the first electronic device corresponds to the location of the first remote input device (e.g., based on the strength of the Bluetooth connection as discussed above), the first visual indicator is expanded to occupy all and/or a significant portion (e.g., 50%, 60%, 70%, 75%, 80%, 90%, etc.) of the finding user interface. For example, the finding user interface is shaded/tinted/overlaid with a color, shade, tint, filter, etc. corresponding to the first visual indicator. Thus, the first visual indicator (e.g., the bubble-shaped affordance) is updated “live” to visually provide an indication of a current distance between the first electronic device and the first remote input device. Displaying a finding user interface for locating a remote input device that includes a first visual indicator in response to detecting selection of a first option in a remote-control user interface enables the user to efficiently track the location of the remote input device for locating the remote input device and/or provides a visual indication of a relative distance to the remote input device, thereby improving user-device interaction.

In some embodiments, the finding user interface includes a textual indication of a distance of the first remote input device relative to the first electronic device, such as textual indication 627 as shown in FIG. 6F. For example, the electronic device displays, below or above the first visual indicator discussed above, an indication of a distance (e.g., 1 foot, 5 feet, 20 feet, 50 feet, 100 feet, etc.) between the first electronic device and the first remote input device. In some embodiments, the textual indication of the distance of the first remote input device relative to the first electronic device is expressed in terms of descriptive phrases/terms (e.g., “far”, “near”, or “here”), rather than units of distance. In some embodiments, the textual indication of the distance to the first remote input device relative to the first electronic device is updated based on changes in the distance between the electronic device and the first destination. For example, while the finding user interface for locating the first remote input device is displayed, as the user of the first electronic device moves closer to the location corresponding to the first remote input device, the indication of the distance decreases and/or changes because the distance between the first electronic device and the first remote input device decreases in accordance with the movement of the user (e.g., the strength of the Bluetooth connection between the first electronic device and the first remote input device increases as similarly discussed above). As another example, the textual indication of the distance to the first remote input device relative to the first electronic device optionally changes based on a change in the location of the first remote input device. For example, while the user of the first electronic device is moving toward the location of the first remote input device, if the location of the first remote input device changes based on movement of a second user (or a pet), the textual indication of the distance to the location of the first remote input device relative to the first electronic device increases or decreases based on a net (e.g., sum or difference) change in distance between the first electronic device and the first remote device (e.g., based on the Bluetooth connection between the first electronic device and the first remote input device, as discussed above). Displaying a finding user interface for locating a remote input device that includes a textual indication of a distance to the remote input device in response to detecting selection of a first option in a remote-control user interface enables the user to efficiently track the location of the remote input device for locating the remote input device and/or provides a visual indication of the relative distance to the remote input device, thereby improving user-device interaction.

In some embodiments, while displaying the finding user interface, the first electronic device receives an indication that the first remote input device has detected user interaction, as similarly described with reference to FIG. 6I. For example, while the first electronic device is tracking the location of the first remote input device (e.g., based on the Bluetooth connection between the first electronic device and the first remote input device, as similarly discussed above), the first remote input device detects user interaction, such as user input, directed to the first remote input device. In some embodiments, the first remote input device detects a selection or press of a physical button on the first remote input device. In some embodiments, the first remote input device detects a tap, press, and/or swipe of a contact (e.g., a finger of a hand, a stylus, or other input mechanism) on a touch-sensitive surface of the first remote input device. In some embodiments, the first remote input device detects motion/movement of the first remote input device (e.g., via an accelerometer or gyroscope of the first remote input device). In some embodiments, the user interaction is provided by the user of the first electronic device (e.g., intentionally or unintentionally), by a second user, different from the user, by a pet, etc. In some embodiments, when the first remote input device detects the user interaction, the first remote input device transmits an indication of the user interaction to the first electronic device.

In some embodiments, in response to receiving the indication, the first computer system displays, via the display generation component, a user interface element (e.g., notification 632 in FIG. 6I) that includes a first option that is selectable to cease display of the finding user interface (e.g., first option 631-1 in FIG. 6I) and a second option that is selectable to maintain display of the finding user interface (e.g., second option 631-2 in FIG. 6I). For example, in response to receiving the indication from the first remote input device (e.g., or from a server (e.g., a wireless communications terminal) in communication with the first remote input device and the first electronic device), the first electronic device displays a user interface element alerting the user of the first electronic device that the first remote input device has detected the user interaction. In some embodiments, the user interface element includes a message or other textual indication of the user interaction. In some embodiments, the user interface element prompts the user of the first electronic device to provide user input for managing the current finding of the first remote input device. For example, the first remote input device detecting the user interaction possibly indicates that the first remote input device has been located (e.g., by the user or by the second user discussed above). Accordingly, the user interface element optionally includes the first option and the second option discussed above. For example, if the first remote input device has been located by the user or the second user, the user is able to select the first option to end the finding of the first remote input device and cease display of the finding user interface. However, if the first remote input device has not been located by the user or the second user (e.g., the user interaction directed to the first remote input device was unintentional), the user is able to select the second option to continue finding the first remote input device and maintain display of the finding user interface. While displaying a finding user interface for locating a remote input device, displaying a first option that is selectable to cease display of the finding user interface and a second option that is selectable to maintain display of the finding user interface in response to receiving an indication of user interaction detected by the remote input device facilitates discovery that the remote input device has detected the user interaction, which provides the user with an indication that the remote input device has been located by another user and/or is proximate to the user, and/or reduces the number of inputs needed to cease display of the finding user interface, thereby improving user-device interaction.

In some embodiments, the remote-control user interface is currently selected to control the second electronic device (e.g., as similarly discussed above), such as electronic device 514 in FIG. 6M, and the second electronic device is displaying, via a second display generation component (e.g., different from the display generation component in communication with the first electronic device) of the second electronic device, a respective content item within a playback user interface, such as playback user interface 640 in FIG. 6M. For example, the respective content item is being played back in the playback user interface. In some embodiments, the playback user interface corresponds to a content player, such as a movie player or other media player configured to playback content, such as a movie, an episode of a television (TV) show, music, a podcast, etc. In some embodiments, the first electronic device is displaying the remote-control user interface while the second electronic device is displaying the respective content item within the playback user interface.

In some embodiments, the remote-control user interface further includes, in accordance with a determination that the respective content item is a live content item (e.g., Live Content B in FIG. 6N), one or more selectable options for controlling playback of the live content item within the playback user interface, such as controls 616-1-616-5 in FIG. 6N, including a first selectable option (e.g., channel navigation option 616-5 in FIG. 6N). For example, the second electronic device is displaying a live-broadcast and/or live-streamed content item, such as a live-broadcast movie, TV episode, sporting event (e.g., a baseball game, basketball game, football game, soccer game, etc.), awards show, political debate (e.g., presidential debate), competition/game show, etc., in the playback user interface. In some embodiments, the live-broadcast and/or live-streamed content item is of a live event (e.g., an event happening live, at the current time) or of a previously recorded live event (e.g., an event that happened in the past). In some embodiments, a current playback position within the live-broadcast content item is at the live edge. For example, portions of the live-broadcast content item beyond the live edge (e.g., scheduled to be played back at a future time from the current playback position) are not yet available for consumption (e.g., haven't yet been received/streamed by the electronic device from the content provider). In some embodiments, in accordance with the determination that the second electronic device is displaying the live content item (e.g., based on display data received from the second electronic device that includes information corresponding to the live content item), the first electronic device displays the one or more selectable options for controlling playback of the live content item within the playback user interface at the second electronic device. In some embodiments, the first electronic device determines that the respective content item is a live content item based on information provided by an application with which the playback user interface is associated. For example, if the playback user interface is associated with a live content provider application, such as an application of a network provider or other content provider of live content, the first electronic device determines that the respective content item is a live content item. In some embodiments, the one or more selectable options are displayed overlaid on a portion of the touch input region discussed above with reference to steps 702-710 of the remote-control user interface. For example, the one or more selectable options are displayed along a bottom edge of the touch input region in the remote-control user interface. In some embodiments, as similarly discussed above with reference to steps 702-710, the one or more selectable options enable the user to pause, fast-forward, and/or rewind the live content item, select viewing options for the live content item, and/or cease display of the live content item (e.g., and/or initiate a process for selecting a different live content item for playback). In some embodiments, if the respective content item is a live content item, the one or more selectable options include a first selectable option. In some embodiments, the first selectable option corresponds to a channel navigation option (e.g., for switching to a different channel (e.g., media provider) that is playing back a different live content item). For example, the channel navigation option enables the user to initiate a process for selecting a different live content item for playback within the playback user interface from a different media provider.

In some embodiments, the remote-control user interface further includes, in accordance with a determination that the respective content item is an on-demand content item (e.g., Content A in FIG. 6M), a subset of the one or more selectable options, which does not include the first selectable option, such as forgoing display of the channel navigation option 616-5 in the remote-control user interface 602 as shown in FIG. 6M. For example, the respective content item is an on-demand content item (e.g., a content item available for purchase or streaming from a respective media provider at any time, optionally unlike a live content item). In some embodiments, as similarly discussed above, the first electronic device determines that the respective content item is an on-demand content item based on display data received from the second electronic device that includes information corresponding to the on-demand content item. In some embodiments, the first electronic device determines that the respective content item is an on-demand content item based on information provided by an application with which the playback user interface is associated, as similarly discussed above. In some embodiments, in accordance with the determination that the second electronic device is displaying the on-demand content item, the first electronic device displays the subset of the one or more selectable options for controlling playback of the on-demand content item within the playback user interface at the second electronic device. For example, the first electronic device displays one or more of the one or more selectable options discussed above but does not display all of the one or more selectable options. Particularly, the first electronic device forgoes displaying the first selectable option (e.g., the channel navigation option) discussed above. For example, the first electronic forgoes displaying the channel navigation option when an on-demand content item is displayed in the playback user interface because the playback user interface that is displaying the on-demand content item is not associated with an application that includes an accumulation/aggregation of media providers (e.g., the channel navigation option effectively optionally has no function when the on-demand content item is displayed). In some embodiments, displaying the subset of the one or more selectable options includes forgoing displaying the one or more selectable options. Thus, the display of the one or more selectable options, including the first selectable option, is based on whether the content displayed in the playback user interface is live content or on-demand content. Selectively displaying a channel navigation option in a remote-control user interface that is configured to control playback of content in a playback user interface displayed at second electronic device based on whether the content is live content or on-demand content facilitates discovery that the content being played back is live content or on-demand content and/or helps reduce and/or prevent erroneous inputs directed to the channel navigation option when the content is on-demand, thereby improving user-device interaction.

In some embodiments, while displaying the one or more selectable options, including the first selectable option, in the remote-control user interface in accordance with the determination that the respective content item is a live content item, the first electronic device detects, via the one or more input devices, a second input corresponding to selection of the first selectable option, such as a tap of contact 603n on the touchscreen 504 directed to the channel navigation option 616-5 as shown in FIG. 6N. For example, the first electronic device detects a selection input having one or more characteristics of the selection input discussed above with reference to steps 702-710. In some embodiments, in response to detecting the second input, the first electronic device updates display, via the display generation component, of the first selectable option to concurrently display a first respective option (e.g., up key 618-1 in FIG. 6O) and a second respective option (e.g., down key 618-2 in FIG. 6O). For example, before detecting the selection of the first selectable option, the first electronic device displays the first selectable option with a first visual appearance and/or in a first visual state in the remote-control user interface. As an example, the first selectable option is displayed at a first size and/or with a first visual prominence (e.g., boldness, color, shading, etc.) in the remote-control user interface. In some embodiments, when the first electronic device detects the selection of the first selectable option, the first electronic device displays the first selectable option with a second visual appearance, different from the first visual appearance, and/or in a second visual state, different from the first visual state, in the remote-control user interface. For example, the first selectable option is displayed at a second size, larger from the first size, and/or with a second visual prominence, greater than the first visual prominence in the remote-control user interface. In some embodiments, displaying the first selectable option at the second size and/or with the second visual prominence includes updating the first selectable option to concurrently include the first respective option and the second respective option. For example, the channel navigation option is increased in size to include, within and/or overlaid on the channel navigation option, an up arrow key (e.g., a channel up option) and a down arrow key (e.g., a channel down option). In some embodiments, the first respective option is selectable to navigate to a channel (e.g., a media provider) that is chronologically located above a channel number associated with the channel of the live content item that is currently being played back in the playback user interface. Similarly, in some embodiments, the second respective option is selectable to navigate to a channel that is chronologically located below the channel number associated with the channel of the live content item. For example, selecting the first respective option or the second respective option in the remote-control user interface causes the second electronic device to “change the channel”, such that a different live content item is played back in the playback user interface. In some embodiments, before detecting the second input, the first selectable option includes visual representations of the first respective option and the second respective option (e.g., visual representations of the channel up and the channel down options), however, the first respective option and the second respective option are not individually selectable within the first selectable option until the second input is detected. For example, as discussed above, when the first selectable option is selected, the first selectable option grows/expands in size such that the visual representations of the first respective option and the second respective option become individually selectable within the first selectable option (e.g., duc to the increased size and/or visual prominence of the first selectable option). Expanding a channel navigation option in a remote-control user interface to include a channel up and a channel down options for controlling playback of content in a playback user interface displayed at second electronic device in response to detecting a selection of the channel navigation option helps improve efficiency for selecting the channel up and channel down options and/or helps reduce and/or prevent unintentional changing of the content in the playback user interface caused by erroneous inputs directed to the channel navigation option, thereby improving user-device interaction.

In some embodiments, while displaying the remote-control user interface, the first electronic device detects, via the one or more input devices, a sequence of one or more inputs corresponding to a request to display a user interface of an item locating application, as similarly described with reference to FIG. 6K. In some embodiments, the sequence of one or more inputs includes a first input for minimizing (e.g., ceasing) display of the remote-control user interface. For example, the first electronic device detects selection of a button (e.g., a home button) of the first electronic device that causes minimization of the remote-control user interface. In some embodiments, the first electronic device detects a swipe gesture on a touch-sensitive surface of the first electronic device. For example, the first electronic device detects a swipe of a contact (e.g., a finger of the user or a stylus) in a respective direction (e.g., upward or downward) on a touchscreen of the first electronic device. In some embodiments, the sequence of one or more inputs incudes a second input for launching the item locating application. For example, after the remote-control user interface is minimized, the first electronic device displays a home screen user interface of the first electronic device that includes a plurality of user interface objects (e.g., icons) corresponding to applications. In some embodiments, the first electronic device detects a selection of a user interface object (e.g., icon) that corresponds to the item locating application. In some embodiments, the sequence of one or more inputs includes selection of the first selectable option discussed above with reference to steps 702-710 and a determination that the first remote input device is outside the threshold distance of the first electronic device. For example, in response to detecting the selection of the first selectable option in the remote-control user interface, in accordance with the determination that the first remote input device is outside the threshold distance of the first electronic device, the first electronic device ceases display of the remote-control user interface and (e.g., automatically) launches the item locating application.

In some embodiments, in response of detecting the sequence of one or more inputs, the first electronic device displays, via the display generation component, the user interface of the item locating application (e.g., user interface 630 in FIG. 6L), wherein the user interface includes a plurality of representations of a plurality of findable items (e.g., items 632-1-632-4 in list 636 in FIG. 6L) that indicates locations of the plurality of findable items. In some embodiments, in response to the receiving the sequence of one or more inputs, the display generation component displays a user interface of an item locating application. In some embodiments, the item locating application is an application that displays one or more representations of one or more findable items and/or users along with indications of the locations of the one or more findable items and/or users. In some embodiments, the user opens the item locating application to view one or more items that the user owns or has gained access to via invitation. In some embodiments, the user selects one or more of the items to locate, and in response, the item locating application optionally displays to the user an indication of the location of the selected one or more items (e.g., on a map). For example, the user interface of the item locating application includes the display of a map of a physical region surrounding the location of the user of the first electronic device. In some embodiments, the map region includes the location of the user. In some embodiments, the plurality of representations of the plurality of findable items is represented on the map as bubbles and/or circles. However, it should be understood that these representations are optionally any shape and/or size.

In some embodiments, in accordance with the determination that the one or more first criteria are satisfied (e.g., because the first remote input device is a findable item, as previously discussed above), the first electronic device displays a representation of the first remote input device that indicates a location of the first remote input device, such as representation 631-2 on map 635 as shown in FIG. 6L. In some embodiments, if the one or more first criteria are satisfied, the location of the first remote input device is trackable via the item locating application, and the user interface of the item locating application optionally includes a representation of the first remote input device along with an indication of the location of the first remote input device. The location is optionally indicated on a virtual map, on a list, within an alternative user interface, or the like associated with the item finding application. For example, the location of the first remote input device is indicated by a representation of the first remote input device (e.g., an image of the first remote input device or a cartoon representation of the first remote input device) displayed at a location on the map corresponding to the location of the first remote input device. In some embodiments, the location of the first remote input device is indicated by a representation of the first remote input device in a list of findable items, wherein the first remote input device is shown next to a text description of a location of the first findable item and/or a distance of the first findable item from the first electronic device. In some embodiments, this list view displays a single findable item or multiple findable items (and/or other users). In some embodiments, selection of the representation of the first remote input device enables the user to initiate a process to track and/or navigate to a current location of the first remote input device (e.g., via a maps application of the first electronic device). In some embodiments, selection of the representation of the first remote input device enables the user to initiate finding of the first remote input device via a finding user interface (e.g., similar to the finding user interface discussed above) that is associated with the item locating application. Displaying an indication of a location of a remote input device that is associated with a second electronic device in a user interface of an item locating application provides a visual indication of the relative location of the remote input device and/or enables the user of the first electronic device to track the location of the remote input device, thereby improving user-device interaction and enabling the user to more quickly and accurately determine the location of the remote input device.

It should be understood that the particular order in which the operations in method 700 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein are also applicable in an analogous manner to method 700 described above with respect to FIG. 7. For brevity, these details are not repeated here.

The operations in the information processing methods described above are, optionally, implemented by running one or more functional modules in an information processing apparatus such as general purpose processors (e.g., as described with respect to FIGS. 1A-1B, 3, 5A-5C) or application specific chips. Further, the operations described above with reference to FIG. 7 are, optionally, implemented by components depicted in FIGS. 1A-1B. For example, detecting operation 708 and displaying operation 702 are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology potentially involves the gathering and use of data available from specific and legitimate sources to display content or suggest content for display to users. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information, usage history, handwriting styles, etc.

The present disclosure recognizes that the use of such personal information data in the present technology can be used to the benefit of users. For example, the personal information data can be used to automatically perform operations with respect to suggesting content items for consumption. Accordingly, use of such personal information data enables users to enter fewer inputs to perform an action with respect to displaying and interacting with content. Further, other uses for personal information data that benefit the user are also contemplated by the present disclosure. For instance, user preferences may be used to identify content items suggested for consumption by the user.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the user is able to configure one or more electronic devices to change the discovery or privacy settings of the electronic device. For example, the user can select a setting that only allows an electronic device to access certain of the user's preferences when suggesting content items for consumption.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at a first electronic device in communication with a display generation component and one or more input devices:
displaying, via the display generation component, a remote-control user interface, wherein input directed to the remote-control user interface is configured to control a respective electronic device, different from the first electronic device, and the remote-control user interface includes:
a remote device selection user interface including a representation of a second electronic device, different from the first electronic device, that is controllable from the remote-control user interface; and
in accordance with a determination that one or more first criteria are satisfied, a first option associated with a first remote input device that is associated with the second electronic device;
while displaying the remote-control user interface and the remote device selection user interface, detecting, via the one or more input devices, a first input corresponding to selection of the first option; and
in response to detecting the first input, in accordance with a determination that the first remote input device is within a threshold distance of the first electronic device when the first input is detected, initiating a process to find the first remote input device.

2. The method of claim 1, wherein satisfaction of the one or more first criteria is based on a determination that a respective remote input device that is associated with a respective electronic device is a findable item.

3. The method of claim 1, wherein:
the remote-control user interface includes a first user interface object indicating a respective electronic device that the remote-control user interface is currently selected to control; and
the remote device selection user interface is displayed in the remote-control user interface in response to detecting a selection of the first user interface object.

4. The method of claim 3, wherein:
the remote-control user interface is currently selected to control the second electronic device; and
the representation of the second electronic device is displayed with a visual indication that the remote-control user interface is currently selected to control the second electronic device.

5. The method of claim 3, wherein the remote device selection user interface further includes:
a representation of a third electronic device, different from the first electronic device and the second electronic device, that is controllable from the remote-control user interface; and
in accordance with a determination that one or more second criteria are satisfied, a second option associated with a second remote input device, different from the first remote input device, that is associated with the third electronic device.

6. The method of claim 1, wherein initiating the process to find the first remote input device includes displaying, via the display generation component, a finding user interface.

7. The method of claim 6, wherein the finding user interface includes a first visual indicator that visually indicates a distance of the first remote input device relative to the first electronic device.

8. The method of claim 6, wherein the finding user interface includes a textual indication of a distance of the first remote input device relative to the first electronic device.

9. The method of claim 6, further comprising:
while displaying the finding user interface, receiving an indication that the first remote input device has detected user interaction; and
in response to receiving the indication:
displaying, via the display generation component, a user interface element that includes a first option that is selectable to cease display of the finding user interface and a second option that is selectable to maintain display of the finding user interface.

10. The method of claim 1, wherein:
the remote-control user interface is currently selected to control the second electronic device;
the second electronic device is displaying, via a second display generation component of the second electronic device, a respective content item within a playback user interface; and
the remote-control user interface further includes:
in accordance with a determination that the respective content item is a live content item, one or more selectable options for controlling playback of the live content item within the playback user interface, including a first selectable option; and
in accordance with a determination that the respective content item is an on-demand content item, a subset of the one or more selectable options, which does not include the first selectable option.

11. The method of claim 10, further comprising:
while displaying the one or more selectable options, including the first selectable option, in the remote-control user interface in accordance with the determination that the respective content item is a live content item, detecting, via the one or more input devices, a second input corresponding to selection of the first selectable option; and
in response to detecting the second input:
updating display, via the display generation component, of the first selectable option to concurrently display a first respective option and a second respective option.

12. The method of claim 1, further comprising:
while displaying the remote-control user interface, detecting, via the one or more input devices, a sequence of one or more inputs corresponding to a request to display a user interface of an item locating application; and
in response of detecting the sequence of one or more inputs:
displaying, via the display generation component, the user interface of the item locating application, wherein the user interface includes a plurality of representations of a plurality of findable items that indicates locations of the plurality of findable items, including:
in accordance with the determination that the one or more first criteria are satisfied, a representation of the first remote input device that indicates a location of the first remote input device.

13. A first electronic device, comprising:
one or more processors;
memory; and
one or more programs, wherein the one or more programs are stored in the memory and configured to be executed by the one or more processors, the one or more programs including instructions for:
displaying, via a display generation component, a remote-control user interface, wherein input directed to the remote-control user interface is configured to control a respective electronic device, different from the first electronic device, and the remote-control user interface includes:
a remote device selection user interface including a representation of a second electronic device, different from the first electronic device, that is controllable from the remote-control user interface; and
in accordance with a determination that one or more first criteria are satisfied, a first option associated with a first remote input device that is associated with the second electronic device;
while displaying the remote-control user interface and the remote device selection user interface, detecting, via one or more input devices, a first input corresponding to selection of the first option; and
in response to detecting the first input, in accordance with a determination that the first remote input device is within a threshold distance of the first electronic device when the first input is detected, initiating a process to find the first remote input device.

14. A non-transitory computer readable storage medium storing one or more programs, the one or more programs comprising instructions, which when executed by one or more processors of a first electronic device, cause the first electronic device to perform a method comprising:
displaying, via a display generation component, a remote-control user interface, wherein input directed to the remote-control user interface is configured to control a respective electronic device, different from the first electronic device, and the remote-control user interface includes:
a remote device selection user interface including a representation of a second electronic device, different from the first electronic device, that is controllable from the remote-control user interface; and
in accordance with a determination that one or more first criteria are satisfied, a first option associated with a first remote input device that is associated with the second electronic device;
while displaying the remote-control user interface and the remote device selection user interface, detecting, via one or more input devices, a first input corresponding to selection of the first option; and
in response to detecting the first input, in accordance with a determination that the first remote input device is within a threshold distance of the first electronic device when the first input is detected, initiating a process to find the first remote input device.
